(19) United States
(12) Patent Application Publication
(10) Pub. No.: US 2003/0225680 A1
(43) Pub. Date: Dec. 4, 2003

(54) Escrow management system

(76) Inventor: James F. Desmond, Phoenix, AZ (US)

Correspondence Address: STONEMAN LAW OFFICES, LTD, 3113 NORTH 3RD STREET, PHOENIX, AZ, 85012, US

(21) Appl. No.: 10/441,774

(22) Filed: May 19, 2003

Related U.S. Application Data
(60) Provisional application No. 60/381,480, filed on May 17, 2002.

(51) Int. Cl. G06F 17/60

(52) U.S. Cl. 705/37

(57) ABSTRACT

A method and system (software) is described with features for sharing proceeds, from sales of mutually owned assets by auction services, held in escrow for multiple parties entitled to the proceeds. Further, other areas addressed by a preferred embodiment of the present invention include relating multiple independent escrows with a single case, control and management of the case (including all escrows, completion of the sale of assets through auction services and delivery of the assets to the buyer) by legal representatives representing the entitled parties, and permitting variable percentage sharing with different escrows for a case. Additional areas addressed by a preferred embodiment of the present invention include integrating closely with auction services to facilitate a smooth and efficient sale of assets, operating as an Internet-based service integrated with Internet-based auction services, and delivery of particular assets by selected brokers such as jewelry stores with public locations nationally.

### BACKGROUND

The present invention relates generally to methods of escrow for sharing revenue between multiple parties resulting from disposing of mutually owned assets through auction services.

Division of mutually owned assets as part of a divorce often requires that the values be determined by an independent third party, the highest value possible is received for an asset and that the proceeds are divided according to an agreed percentage split as soon as possible. Historically, the parties in a divorce have been confronted with an inability to meet these goals. First, there is often disagreement over the value of the assets. Second, the best manner of disposition is subject to disagreement and negotiation. Finally, the disposition of any particular asset is usually the responsibility of one of the parties, which often raises the problem of timely sharing of the proceeds between the parties. It is clear that these issues apply to mutually owned assets of all kinds.

These same problems confront the courts and administrators in the distribution of assets from a decedent's estate. It is desirable to obtain the highest possible value for the assets from an independent source. Then, once an asset is sold, the goal is to distribute the proceeds according to a set percentage split.

Disposition of assets in a bankruptcy is still another area which faces the same requirements with no easy solution. In each case, assets can be auctioned, establishing an independent value for an asset that may result in a prompt sale. However, live auctions can be expensive and poorly attended, resulting in reduced values for the assets and a variety of costs that must be paid out of the proceeds. Even when an item is sold, distribution of the proceeds must still be accomplished. Also, the task can be complicated when the percentage sharing arrangements vary from one asset to another.

Escrow accounts can be used to hold the proceeds from asset sales in these environments but are expensive and limited in their ability to manage different assets and the different percentage sharing arrangements.

Additionally, while escrow services and auction services are available to attorneys, they are not well integrated with the tasks necessary to complete the disposition of assets from, for example, a divorce, bankruptcy or estate sale.

Recently, a wide range of interactive devices has been developed to provide information to a variety of users via communications networks. These interactive devices include, for example, computers connected to various computer on-line services, interactive kiosks, interactive television systems, a variety of other wired and wireless devices, such as personal digital assistants (PDAs), and the like. In particular, the popularity of computer on-line services has grown immensely over the last decade. Computer on-line services are provided by a wide variety of different companies.

In general, most computer on-line services are accessed via the Internet. The Internet is a global network of computers. One popular part of the Internet is the World Wide Web, or just “the Web.” The World Wide Web contains computers that display graphical and textual information. Computers that provide information on the World Wide Web are typically called “Web sites.” A Web site is defined by an Internet address that has an associated electronic page, often called a “home page.” Generally, a home page is an electronic document that organizes the presentation of text, graphical images, audio and video into a desired display. These Web sites are operated by a wide variety of entities, which are typically called Web site “hosters.”

A user may access the Internet via a dedicated high-speed line or by using a personal computer (PC) equipped with a conventional modem or a variety of other wired and wireless devices. Special interface software, called “browser” software, is installed within the PC or other access device. When the user wishes to access the Internet using a telephone line, a modem is used to dial the telephone number associated with the local Internet host server. The user can then access information at any address accessible over the Internet. Two well-known web browsers, for example, are the Netscape Navigator browser marketed by Netscape Communications Corporation and the Internet Explorer browser marketed by Microsoft Corporation.

Information exchanged over the Internet is typically encoded in Hypertext Mark-up Language (HTML) format. The HTML format is a scripting language that is used to generate the home pages for different content providers. In this setting, a content provider is an individual or company that places information (content) on the Internet so that others can access it. As is well known in the art, the HTML format is a set of conventions for marking different portions of a document so that each portion appears in a distinctive format. For example, the HTML format identifies or “tags” portions of a document to identify different categories of text (e.g., the title, header, body text, etc.). When a web browser accesses an HTML document, the web browser reads the embedded tags in the document so it appears formatted in the specified manner.

An HTML document can also include hyperlinks, which allow a user to move from one document to another document on the Internet. A hyperlink is an underlined or otherwise emphasized portion of text that, when selected using an input device such as a mouse, activates a software connection module that allows the user to jump between documents or pages (i.e., within the same Web site or to other Web sites). Hyperlinks are well known in the art, and have been sometimes referred to as anchors. The act of selecting the hyperlink is often referred to as “clicking on” the hyperlink.

Even with the advent of the Internet and Internet-based auction and escrow services, which are in some ways, somewhat integrated, attorneys are still required to manage the processes of splitting the proceeds and ensuring each party is paid the proper amount in a timely manner.

### OBJECTS OF THE INVENTION

It is an object and feature of this invention provide a solution to these above-mentioned problems of the prior art by presenting a new and effective method and system for managing the disposition of assets, collecting the proceeds and distributing the proceeds to multiple parties based on the defined percentage split.

It is a further object and feature of this invention to provide these functions through an Internet-based interactive escrow system operating in conjunction with an Internet-based auction service. In addition, it is still another object and feature of this invention that the escrow system retains case and escrow account information in such a manner to permit automatic calculation of the amounts due to each entitled party using percentage splits. Still another object and feature of the invention is to permit more than one escrow account to be associated with any case so that entitled parties in a case may have different escrow accounts for different assets being offered for sale.

It is still another object and feature of the invention to provide these services to attorneys representing parties to a divorce. Moreover, it is another object and feature of the invention to provide services to attorneys and administrators responsible for settling a decedent's estate. Additionally, it is another object and feature of the invention to provide services to legal representative associated with these situations.

Furthermore, it is yet another object and feature of the invention to utilize companies with locations nationwide, such as nationwide jewelry store chains and the like, to act as brokers in the description, inspection, acceptance and transfer of assets of very high value.

### SUMMARY OF THE INVENTION

In accordance with a preferred embodiment hereof, this invention provides an escrow system for percentage splitting of proceeds by at least one escrow service from at least one sale on behalf of at least one instructing entity among at least one entitled party comprising, in combination: computer interface means for assisting at least one input of escrow information by at least one instructing entity; computer interface means for assisting at least one input of at least one asset information by at least one instructing entity; computer database means for storing such escrow information; computer database means for storing such asset information; computer processor means for sharing at least some such asset information with at least one auction service; computer processor means for assisting receiving information about at least one buyer from such at least one auction service; computer database means for storing information of such at least one buyer; computer interface means for assisting at least one input of at least one payment from such at least one buyer; computer processor means for assisting shipping such at least one asset to such at least one buyer; computer processor means for calculating amounts due to such at least one auction service for at least one asset purchased; computer processor means for calculating amounts due to such at least one escrow service for such at least one asset purchased; and computer processor means for calculating payment due to such at least one entitled party.

In accordance with another preferred embodiment hereof, this invention provides an escrow system for percentage splitting of proceeds by at least one escrow service from at least one sale on behalf of at least one instructing entity among at least one entitled party comprising, in combination: at least one computer interface system structured and arranged to assist at least one input of escrow information by such at least one instructing entity; at least one computer interface system structured and arranged to assist at least one input of asset information by such at least one instructing entity; at least one database system structured and arranged to store such escrow information; at least one database system structured and arranged to store such asset information; at least one computer processor system structured and arranged to share at least some of such asset information with at least one auction service; at least one computer processor system structured and arranged to receive buyer information about at least one buyer from such at least one auction service; at least one database system structured and arranged to store such buyer information; at least one computer interface system structured and arranged to assist at least one input of payment from such at least one buyer; at least one computer processor system structured and arranged to ship at least one asset to such at least one buyer; at least one computer processor system structured and arranged to calculate amounts due to such at least one auction service for at least one asset purchased; at least one computer processor system structured and arranged to calculate amounts due to such at least one escrow service for such at least one asset purchased; and at least one computer processor system structured and arranged to calculate payment due to such at least one entitled party.

Additionally, it provides such a system wherein such at least one computer interface system structured and arranged to assist at least one input of such payment from such at least one buyer further comprises: at least one computer processor system structured and arranged to create at least one unique password for each such at least one asset purchased; at least one computer processor system structured and arranged to notify such at least one buyer of such at least one unique password for such at least one asset purchased by such at least one buyer; at least one computer interface system structured and arranged to control payment input access utilizing such at least one unique password for such at least one asset purchased; at least one computer interface system structured and arranged to assist at least one input of such payment by such at least one buyer with respect to such at least one asset purchased; and at least one database system structured and arranged to store such payment with respect to such at least one asset purchased from such at least one buyer.

Additionally, it provides such a system wherein such at least one computer processor system structured and arranged to ship such at least one asset to such at least one buyer further comprises: at least one computer processor system structured and arranged to notify at least one shipper of shipping instructions; at least one computer interface system structured and arranged to assist at least one input of at least one date of receipt of such at least one asset by such at least one buyer, provided by such at least one shipper; at least one computer processor system structured and arranged to calculate at least one acceptance period for such at least one buyer based on such at least one date of receipt; at least one computer interface system structured and arranged to assist at least one input of such at least one acceptance notice received during such at least one acceptance period from such at least one buyer of such at least one asset purchased; and at least one computer processor system structured and arranged to complete at least one sale after such at least one acceptance period in the absence of such at least one acceptance notice from such at least one buyer.

Additionally, it provides such a system wherein such at least one computer processor system structured and arranged to notify such at least one shipper of such shipping instructions further comprises: at least one computer interface system structured and arranged to assist at least one input of at least one preferred shipping service; at least one database system structured and arranged for storing such at least one preferred shipping services; at least one computer processor system structured and arranged to select such at least one shipping service with respect to shipping such at least one asset purchased by such at least one buyer; at least one computer interface system structured and arranged to assist at least one input of shipping instructions for such at least one asset purchased by such at least one buyer; at least one computer processor system structured and arranged to notify selected such at least one shipping service of such shipping instructions; and at least one computer processor system structured and arranged to notify such at least one entitled party of such shipping instructions.

Additionally, it provides such a system wherein such at least one computer processor system structured and arranged to calculate such payment amount due to such at least one entitled party further comprises: at least one computer processor system structured and arranged to calculate such payment using at least one asset purchase price, subtracting amount due to such at least one auction service and subtracting amount due to such at least one escrow service.

Additionally, it provides such a system wherein such at least one computer processor system structured and arranged to calculate such payment due to such at least one entitled party further comprises: at least one computer processor system structured and arranged to send such payment to such at least one instructing entity.

Additionally, it provides such a system further comprising: at least one computer interface system structured and arranged to assist at least one input of identification of such at least one asset to be described and held for presentation and safekeeping by at least one brokering entity having at least one public location; at least one computer interface system structured and arranged to assist at least one input of description of such at least one asset by such brokering entity by at least one instructing entity; at least one computer processor system structured and arranged to notify at least one brokering entity of such at least one asset; at least one computer processor system structured and arranged to notify such at least one brokering entity of at least one location of at least one buyer; at least one computer interface system structured and arranged to assist at least one input of at least one acceptance notice from such at least one brokering entity on behalf of such at least one buyer of such at least one asset purchased received during at least one acceptance period; and at least one computer processor system structured and arranged to calculate payment due to such at least one brokering entity.

Additionally, it provides such a system further comprising: at least one computer interface system structured and arranged to assist at least one input of such at least one rejection notice from such at least one buyer of such at least one asset purchased, received during at least one acceptance period; at least one computer processor system structured and arranged to notify at least one shipper of shipping instructions with respect to rejection of such at least one asset purchased; at least one computer interface system structured and arranged to assist at least one input of at least one date of receipt of such at least one rejected asset purchased, provided by such at least one shipper; and at least one computer processor system structured and arranged to return payment from such at least one buyer.

Additionally, it provides such a system wherein such at least one computer interface system structured and arranged to assist at least one input of such at least one rejection notice from such at least one buyer of such at least one asset purchased, received during such acceptance period further comprises: at least one computer interface system structured and arranged to assist at least one input of such at least one rejection notice received during such at least one acceptance period from such at least one brokering entity on behalf of such at least one buyer of such at least one asset purchased.

Additionally, it provides such a system wherein: the escrow system is substantially an Internet website client-server computer system; the auction service is substantially an Internet website client-server computer system; the escrow system and auction service system share asset information; and the escrow system and auction service system share buyer information.

Additionally, it provides such a system wherein: multiple independent escrows are permitted for each such at least one entitled party; each such independent escrow may have a different such percentage split of the proceeds; attorneys are such instructing entities; and such at least one attorney for each such entitled party may receive such proceeds on behalf of such at least one entitle party.

Additionally, it provides such a system wherein: such at least one asset comprises at least one asset derived from a divorce. Additionally, it provides such a system wherein: such at least one asset comprises at least one asset derived from a bankruptcy. Additionally, it provides such a system wherein: such at least one asset comprises at least one asset derived from a decedent's estate.

In accordance with another preferred embodiment hereof, this invention provides a computer software system for an escrow system for percentage splitting of proceeds by at least one escrow service from at least one sale on behalf of at least one instructing entity among at least one entitled party comprising, in combination, the steps of: assisting at least one input of escrow information by at least one instructing entity; assisting at least one input of at least one asset information by at least one instructing entity; storing such escrow information; storing such asset information; sharing at least some such asset information with at least one auction service; receiving information about at least one buyer from such at least one auction service; storing information of such at least one buyer; assisting at least one input of at least one payment from such at least one buyer; shipping such at least one asset to such at least one buyer; calculating amounts due to such at least one auction service for at least one asset purchased; calculating amounts due to such at least one escrow service for such at least one asset purchased; and calculating payment due to such at least one entitled party.

Additionally, it provides such a system wherein such assisting at least one input of such at least one payment from such at least one buyer further comprises the steps of: creating at least one unique password for each such at least one asset purchased; notifying such at least one buyer of such at least one unique password with respect to such at least one asset purchased by such at least one buyer; controlling payment input access using such at least one unique password for such at least one asset purchased; assisting at least one input of such at least one payment by such at least one buyer with respect to such at least one asset purchased; and storing such at least one payment with respect to such at least one asset purchased from such at least one buyer.

Additionally, it provides such a system wherein such shipping such at least one asset to such at least one buyer further comprises the steps of: notifying at least one shipper of shipping instructions; assisting at least one input of date of receipt of such at least one asset by such at least one buyer, provided by such at least one shipper; calculating at least one acceptance period applicable to such at least one buyer based on such at least one date of receipt; assisting at least one input of at least one acceptance notice received during such at least one acceptance period from such at least one buyer of such at least one asset purchased; and completing at least one sale after such at least one acceptance period in the absence of receiving such at least one acceptance notice from such at least one buyer.

Additionally, it provides such a system wherein such notifying such at least one shipper of such shipping instructions further comprises the steps of: assisting input of at least one preferred shipping service; storing such at least one preferred shipping service; selecting such at least one shipping service with respect to shipping such at least one asset purchased by such at least one buyer; assisting at least one input of such shipping instructions with respect to such at least one asset purchased by such at least one buyer; notifying selected such at least one shipping service of such shipping instructions; and notifying such at least one entitled party of such shipping instructions.

Additionally, it provides such a system wherein such calculating such payment due to such at least one entitled party further comprises the steps of: calculating such payment using at least one asset purchase price, subtracting amount due to such at least one auction service and subtracting amount due to such at least one escrow service.

Additionally, it provides such a system wherein such calculating such payment due to such at least one entitled party further comprises the steps of: sending such payment to such at least one instructing entity. Additionally, it provides such a system further comprising the steps of: assisting at least one input of identification of such at least one asset to be described and held for presentation and safekeeping by at least one brokering entity having at least one public location; assisting at least one input of description of such at least one asset by such at least one brokering entity by at least one instructing entity; notifying such at least one brokering entity of such at least one buyer for such at least one asset; notifying such at least one brokering entity of at least one location of such at least one buyer; assisting at least one input of at least one acceptance notice from such at least one brokering entity on behalf of such at least one buyer of such at least one asset purchased received during at least one acceptance period; and calculating payment due to such at least one brokering entity.

Additionally, it provides such a system further comprising the steps of: assisting at least one input of at least one rejection notice from such at least one buyer of such at least one asset purchased, received during at least one acceptance period; notifying at least one shipper of shipping instructions with respect to a rejection of such at least one asset purchased; assisting at least one input of at least one date of receipt of such at least one rejected asset purchased, provided by such at least one shipper; and returning payment from such at least one buyer.

Additionally, it provides such a system wherein such assisting at least one input of such at least one rejection notice from such at least one buyer of such at least one asset purchased, received during such at least one acceptance period further comprises the steps of: assisting at least one input of such at least one rejection notice received during such at least one acceptance period from such at least one brokering entity on behalf of such at least one buyer of such at least one asset purchased.

In accordance with another preferred embodiment hereof, this invention provides an escrow system for percentage splitting of proceeds by at least one escrow service from at least one sale on behalf of at least one instructing entity among at least two entitled parties comprising, in combination, the steps of: soliciting instructing entities to be authorized users of such escrow system; inputting such at least one instructing entity authorized by at least one system administrator to use such escrow system; inputting escrow information by such at least one instructing entity; inputting information about at least one asset to be sold by such at least one instructing entity; sending such asset information to at least one auction service; receiving buyer information from such at least one auction service; receiving at least one payment from such at least one buyer of such at least one asset; shipping such at least one asset to such at least one buyer by such at least one shipping service; paying at least one auction service fee from such at least one payment from such at least one buyer to such at least one auction service; paying at least one escrow service fee from such at least one payment from such at least one buyer to such at least one escrow service; and paying at least one remainder of such at least one payment from such at least one buyer to such at least one instructing entity.

Additionally, it provides such a system wherein shipping such at least one asset to such at least one buyer by such at least one shipping service further comprising the steps of; notifying at least one shipping service of shipping instructions; notifying such at least one entitled entity of such shipping instructions; receiving at least one date of receipt by such at least one buyer from such at least one shipping service; calculating at least one acceptance period for such at least one buyer based on such at least one date of receipt; and receiving at least one notice of acceptance of such at least one asset from such at least one buyer within such at least one acceptance period.

Additionally, it provides such a system further comprising the step of: completing at least one sale after such at least one acceptance period when no such at least one notice is received from such at least one buyer. Additionally, it provides such a system further comprising the steps of: inputting at least one rejection notice from such at least one buyer of such at least one asset purchased, received during such at least one acceptance period; notifying at least one shipper of shipping instructions for rejected such at least one purchased asset; inputting of at least one date of return of at such least one rejected purchased asset, provided by such at least one shipper; and returning such at least one payment from such at least one buyer to such at least one buyer.

Additionally, it provides such a system further comprising the steps of: inputting of identification of such at least one asset to be described and held for presentation and safekeeping by at least one brokering entity having at least one public location; notifying such at least one brokering entity of such at least one asset to be sold; inputting of at least one description of such at least one asset by such at least one brokering entity by at least one instructing entity; notifying such at least one brokering entity of at least one buyer location; receiving, during such at least one acceptance period, such at least one acceptance notice from such at least one brokering entity on behalf of such at least one buyer of such at least one asset; and inputting at least one brokering entity's fee.

Additionally, it provides such a system wherein the step of inputting such at least one rejection notice from such at least one buyer of such at least one asset purchased, received during such at least one acceptance period further comprises: inputting such at least one rejection notice from such at least one brokering entity on behalf of such at least one buyer of such at least one asset, received during such at least one acceptance period.

### DEFINITIONS, ACRONYMS AND CROSS-REFERENCES

Asset disposition case—This term is sometimes used herein to refer to an agreement between at two parties to dispose of jointly owned assets. Common examples are a divorce, bankruptcy or estate sale where the parties to these proceedings have agreed to sell particular assets and share the proceeds on a percentage basis.

Brokering entity—This term is sometimes used herein to refer to a company which, under an agreement with the applicant, will hold an asset offered for auction and present it to the successful bidder for acceptance, and on acceptance deliver the asset to the successful bidder. A brokering entity will typically have more than one public location accessible by successful bidders.

Escrow—This term is sometimes used herein to refer to money held in trust by a third party to be turned over to the seller only upon acceptance of an asset purchased at auction.

Trust account—This term is sometimes used herein to refer to an account used by lawyers to hold client monies until the completion of a service or incurrence of an expense for which the money was intended.

Internet—This term is sometimes used herein to refer to the “Internet”, an electronic communications network that connects computer networks and organizational computer facilities around the world, and this term as used herein includes any future successor to the Internet or any large WAN having similar capabilities.

Legal representative—This term is sometimes used herein to refer to attorneys selected to represent parties in a divorce, to executors of estates, or to court-appointed bankruptcy administrators. As used herein, legal representative will sometimes include staff of the legal representative who may perform tasks on behalf of the legal representative.

### BRIEF DESCRIPTION OF THE DRAWINGS

FIG. 1 is an illustration of applicant's business method according to a preferred embodiment and the relationships between the parties involved, which method uses an escrow service to manage the sale of assets through an auction service and delivered by a shipping service.

FIG. 2 is an illustration of applicant's business method according to a preferred embodiment and the relationships between the parties involved for assets that are rejected by the buyer and returned to the entitled party by a shipping service.

FIG. 3 is an illustration of applicant's business method according to a preferred embodiment and relationships between the parties involved, which method uses an escrow service to manage the sale for assets sold through the auction service and delivered through a brokering entity.

FIG. 4 is an illustration of an auction service web site map demonstrating the various functions performed according to a preferred embodiment.

FIG. 5 is an illustration of a representative escrow service web site map demonstrating typical escrow service functions and preferred functions used by applicant's customers according to a preferred embodiment.

FIG. 6 is an illustration of a display screen image of the home page for an escrow service web site according to a preferred embodiment.

FIG. 7 is an illustration of a display screen image of a home page after login by a legal representative for an auction service web site according to a preferred embodiment.

FIG. 8 is an illustration of a display screen image of an add DR case page after login by an authorized legal representative for an escrow service web site according to a preferred embodiment.

FIG. 9 is an illustration of a display screen image of a search results page after a search by an authorized legal representative for an escrow service web site according to a preferred embodiment.

FIG. 10 is an illustration of a display screen image of a final add DR case page for an authorized legal representative for an escrow service web site according to a preferred embodiment.

FIG. 11 is an illustration of a display screen image of an add escrow account page for an authorized legal representative for an escrow service web site according to a preferred embodiment.

FIG. 12 is an illustration of a disbursement agreement printed at the request of an authorized legal representative for an escrow service web site according to a preferred embodiment.

FIG. 13 is an illustration of a display screen image of a DR case detail page requested by an authorized legal representative for an escrow service web site according to a preferred embodiment.

FIG. 14 is an illustration of a display screen image of an item list page, for an escrow, requested by an authorized legal representative for an escrow service web site according to a preferred embodiment.

FIG. 15 is an illustration of a display screen image of an item auction status page requested by an authorized legal representative for an escrow service web site according to a preferred embodiment.

FIG. 16 is an illustration of a display screen image of an item's bid history requested by an authorized legal representative for an escrow service web site according to a preferred embodiment.

FIG. 17 is an illustration of a display screen image of a home page for legal representatives after they login to an auction service web site according to a preferred embodiment.

FIG. 18 is an illustration of a display screen image of an escrow management page accessible only by an authorized legal representative for an auction service web site according to a preferred embodiment.

FIG. 19 is an illustration of a display screen image of an error page for legal representatives for an auction service web site according to a preferred embodiment.

FIG. 20 is an illustration of display screen image of an auction item add page entered by an authorized legal representative for an auction service web site according to a preferred embodiment.

FIG. 21 is an illustration of display screen image of an auction item detail page entered by an authorized legal representative for an auction service web site according to a preferred embodiment.

FIG. 22 is an illustration of a display screen image of a home page for an auction service web site according to a preferred embodiment.

FIG. 23 is an illustration of a display screen image of a search result page which results from a keyword search by a user on an auction service web site according to a preferred embodiment.

FIG. 24 is an illustration of a display screen image of an auction item detail page for an auction service web site according to a preferred embodiment.

FIG. 25 is an illustration of a display screen image of an auction item bid page entered by a user for an auction service web site according to a preferred embodiment.

FIG. 26 is an illustration of a display screen image of an auction item bid confirmation page entered by a user for an auction service web site according to a preferred embodiment.

FIG. 27 is an illustration of a display screen image of an auction item bid final confirmation page entered by a user of an auction service web site according to a preferred embodiment.

FIG. 28 is an illustration of a display screen image of an auction item bid list page for a user for an auction service web site according to a preferred embodiment.

FIG. 29 is an illustration of a display screen image of a home page after login by an authorized administrator for an escrow service web site according to a preferred embodiment.

FIG. 30 is an illustration of a display screen image of an escrow activation page for an authorized administrator for an escrow service web site according to a preferred embodiment.

FIG. 31 is an illustration of a display screen image of an escrow activation/deactivation page for an authorized legal representative for an escrow service web site according to a preferred embodiment.

### DETAILED DESCRIPTION OF A PREFERRED EMBODIMENT OF THE INVENTION

According to a preferred embodiment of the present invention, a method and system (software) is described with features for sharing proceeds, from sales of mutually owned assets by auction services, held in escrow for multiple parties entitled to the proceeds. Further, other areas addressed by a preferred embodiment of the present invention include relating multiple independent escrows with a single case, control and management of the case (including all escrows, completion of the sale of assets through auction services and delivery of the assets to the buyer) by legal representatives representing the entitled parties, and permitting variable percentage sharing with different escrows for a case. Additional areas addressed by a preferred embodiment of the present invention include integrating closely with auction services to facilitate a smooth and efficient sale of assets, operating as an Internet-based service integrated with Internet-based auction services, and delivery of particular assets by selected brokers such as jewelry stores with public locations nationally.

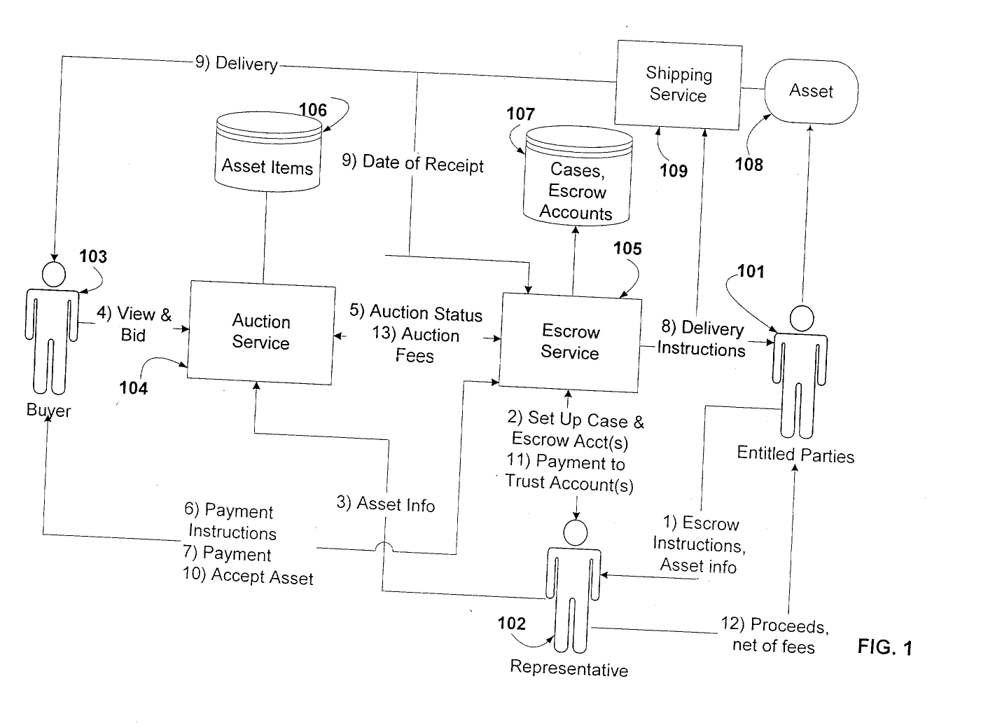

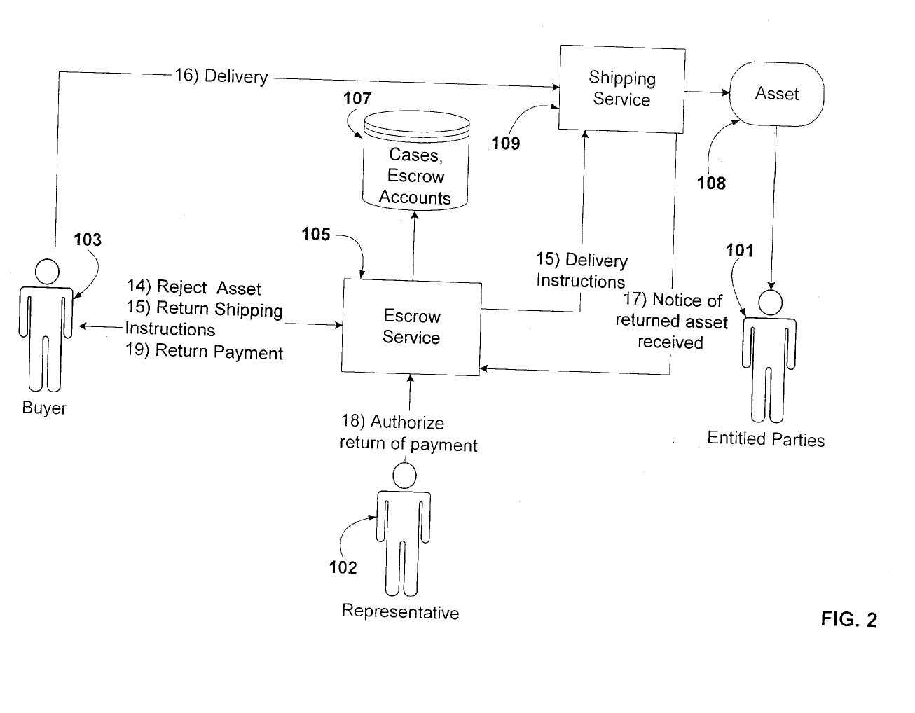

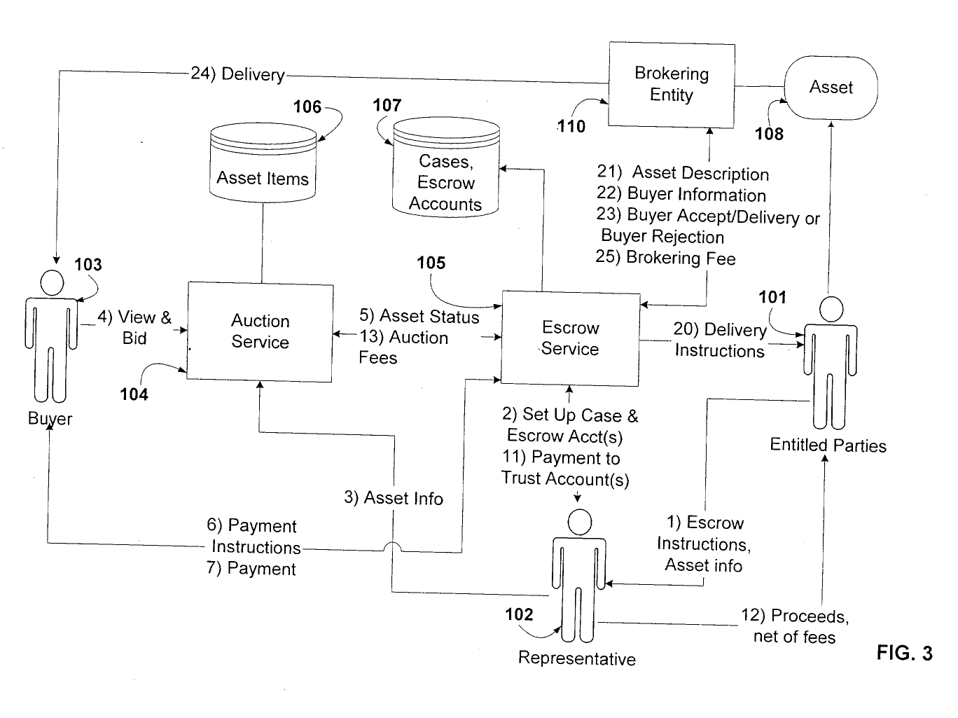

According to a preferred embodiment of the present invention, the components are designed to work together to facilitate the processes of disposing of mutually owned assets and equitable payment of the proceeds to the entitled parties, as in divorces, bankruptcies and estate sales. According to a preferred embodiment of the present invention, the primary system and method of completing the disposition of mutually owned assets could be summarized into thirteen primary steps as shown in FIG. 1. Additional required steps managing rejected assets are illustrated in FIG. 2 and the unique steps for managing sales through brokering entities are shown in FIG. 3.

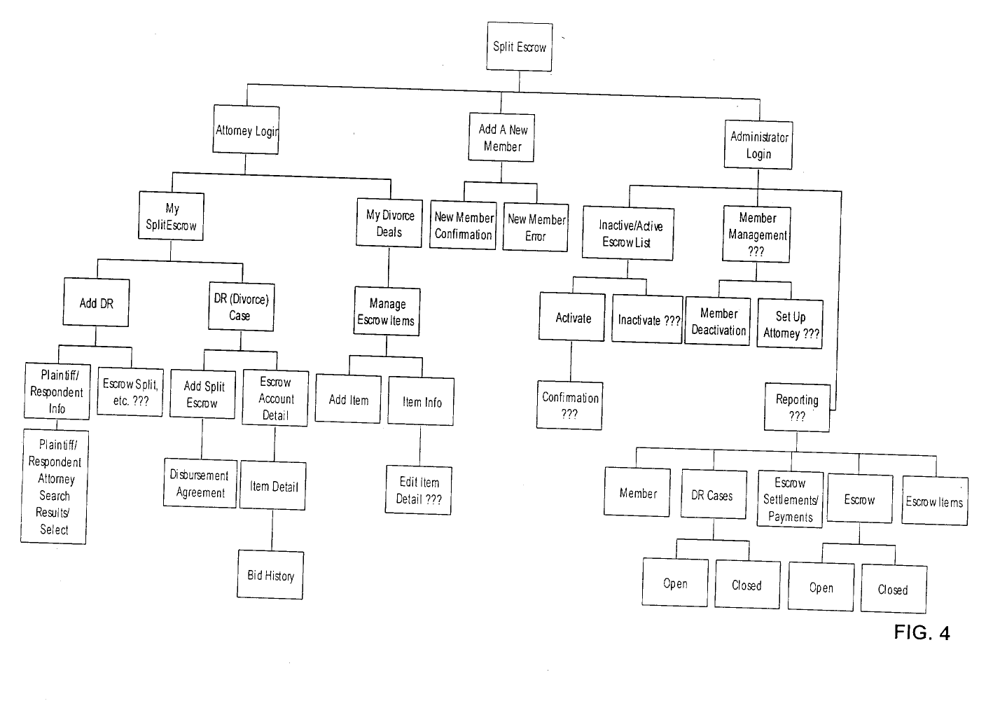

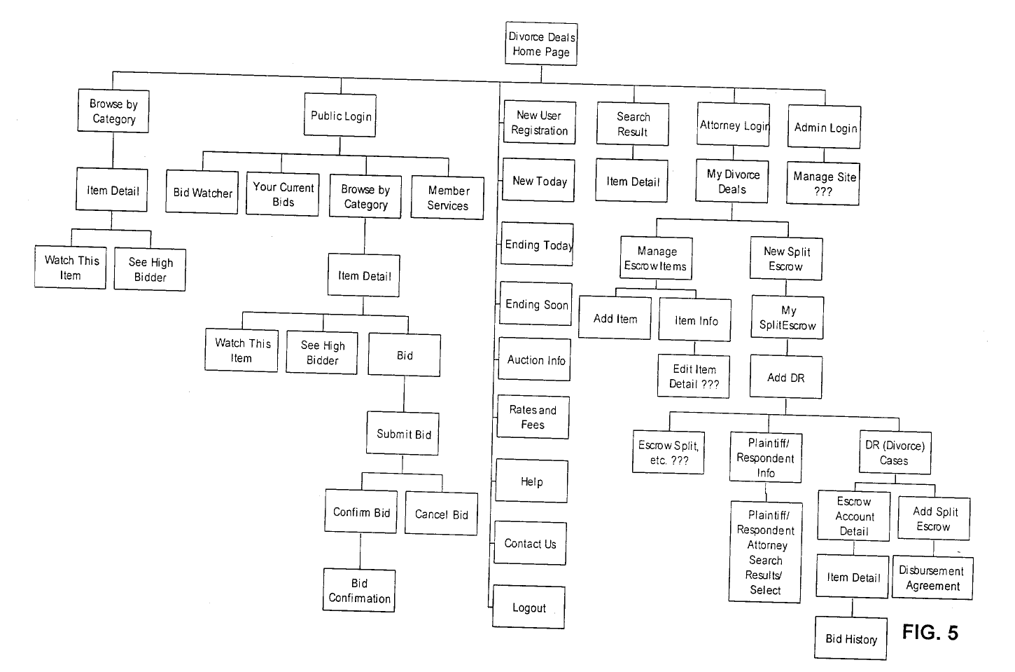

Many of the steps described below are preferably completed using at least one web site preferably designed to assist in the communication and coordination of all the tasks required to complete the sale of an asset and distribution of the proceeds. The primary preferred functions of a preferred Internet-based auction web site application are illustrated in FIG. 3. Moreover, FIG. 4 provides an overview of the primary preferred functions encompassed by an Internet-based escrow service web site application. The following steps are described with reference to the figures (embodying herein computer interface means for assisting at least one input of escrow information by at least one instructing entity; computer interface means for assisting at least one input of at least one asset information by at least one instructing entity; computer database means for storing such escrow information; computer database means for storing such asset information; computer processor means for sharing at least some such asset information with at least one auction service; computer processor means for assisting receiving information about at least one buyer from such at least one auction service; computer database means for storing information of such at least one buyer; computer interface means for assisting at least one input of at least one payment from such at least one buyer; computer processor means for assisting shipping such at least one asset to such at least one buyer; computer processor means for calculating amounts due to such at least one auction service for at least one asset purchased; computer processor means for calculating amounts due to such at least one escrow service for such at least one asset purchased; and computer processor means for calculating payment due to such at least one entitled party).

Step 1

Preferably, one or more entitled parties 101, through their legal representatives 102, request the establishment of a case in which one or more items are to be sold and the proceeds shared on a percentage basis among the entitled parties.

Preferably, entitled parties 101 are the husband and wife and possibly children in a divorce, the creditors and owners in a bankruptcy, or the heirs in the sale of an estate of a deceased person. Upon reading this specification, those skilled in the art will now understand that, under appropriate circumstances, considering such issues as number of assets, cost, lack of cooperation, etc., other entitled parties 101, such as members of a partnership, members of a corporation, co-owners of a business, people living together, etc., may suffice.

Preferably, representative 102 is a legal representative. Upon reading this specification, those skilled in the art will now understand that, under appropriate circumstances, considering such issues as the number of assets, the nature of the assets, cost, lack of cooperation, etc., other representatives 102, such as mediators, arbitrators, non-legal representatives, etc., may suffice.

Preferably, in all cases, the primary considerations, regarding required legal representation, the assets to be sold, and the percentage sharing arrangements, have been resolved prior to the establishment of a case with the applicant. Preferably, an entitled party 101 provides the necessary information about the case and requests that their legal representative 102 initiate auction-based disposition of specified assets. Preferably, the information provided by the entitled party 101 includes information regarding other legal representatives 102 associated with the case, all entitled parties 101, the assets to be sold and the related percentage split to be used for distribution of the net proceeds.

Step 2

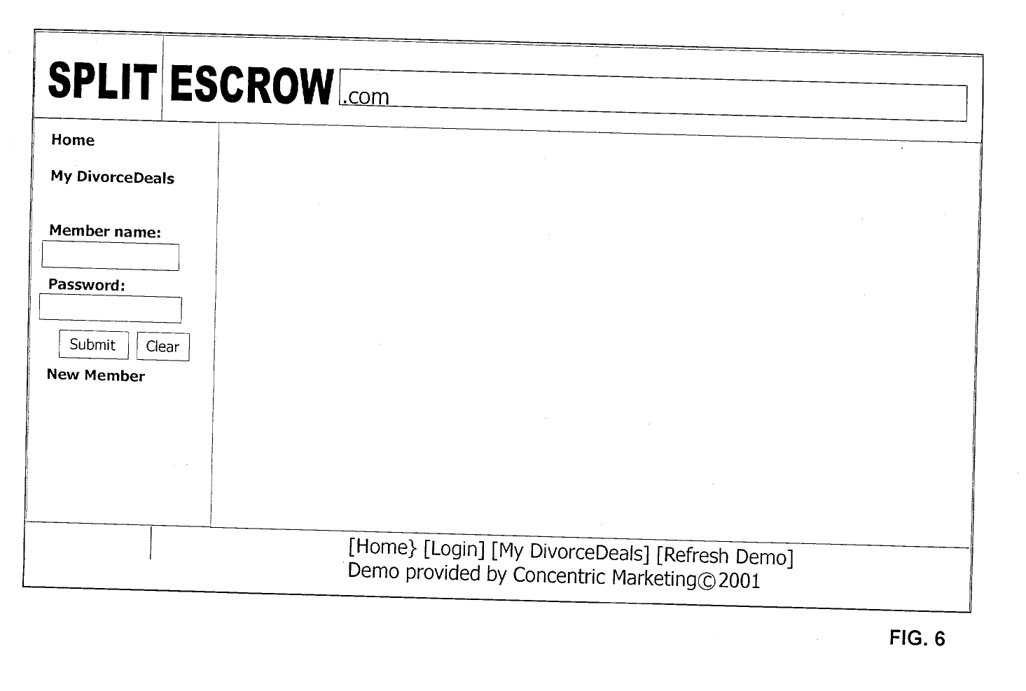

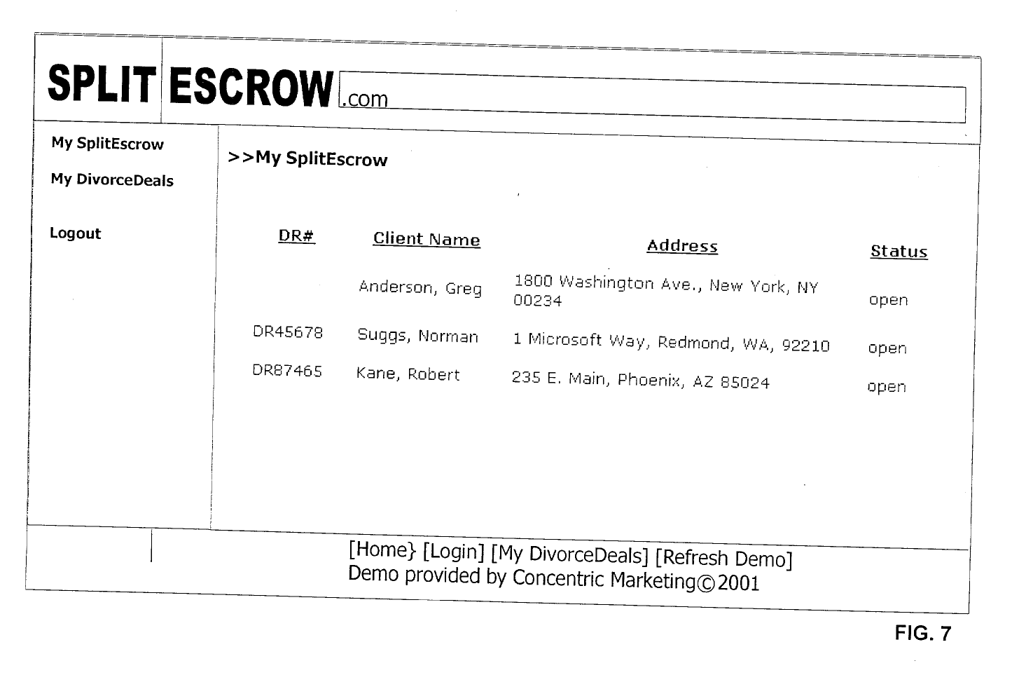

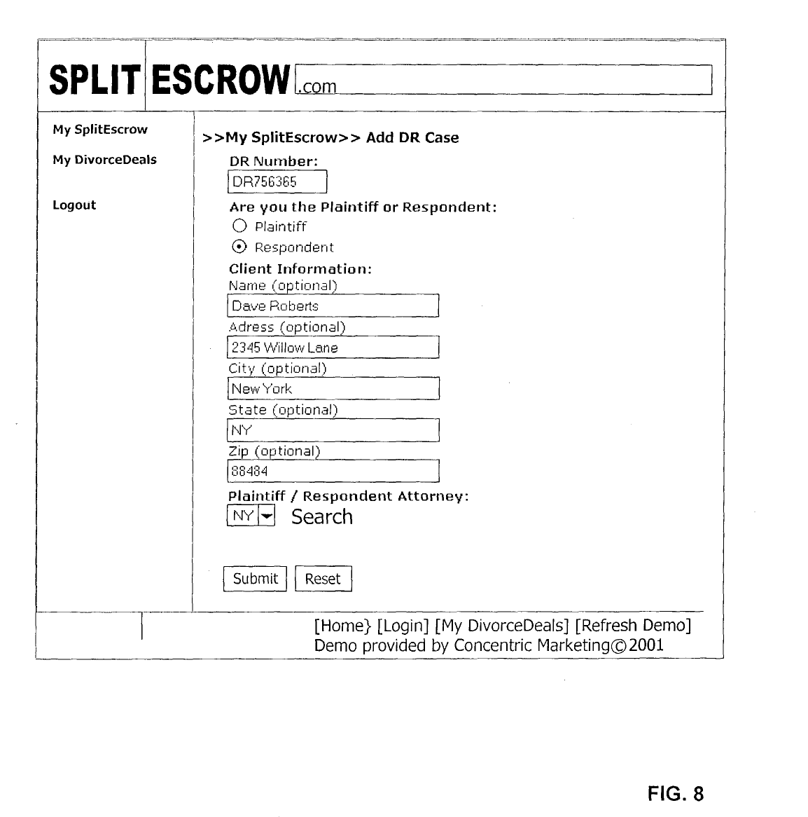

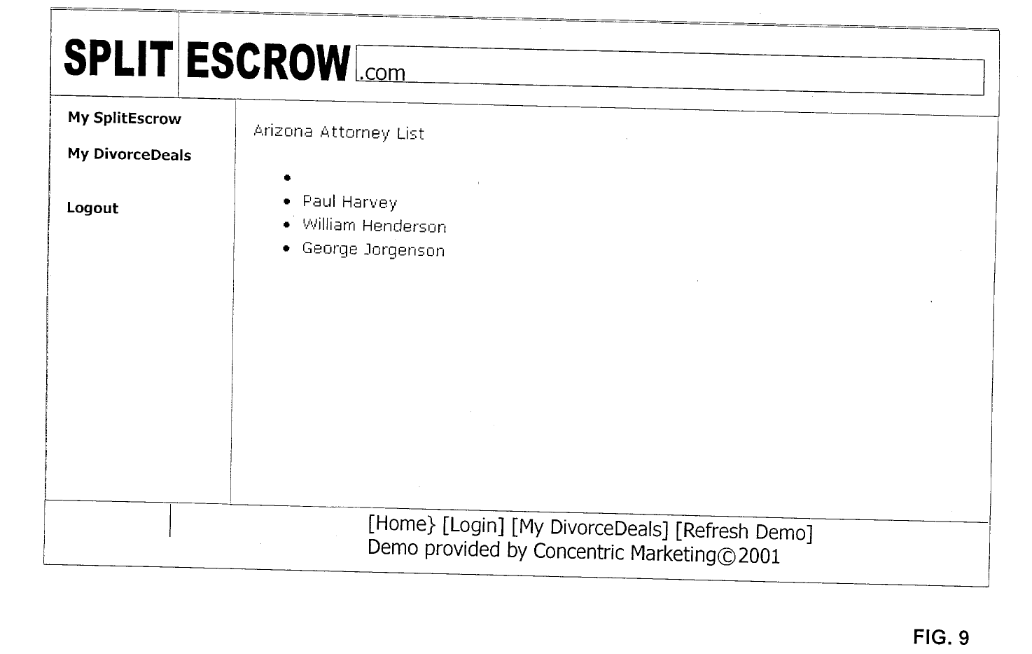

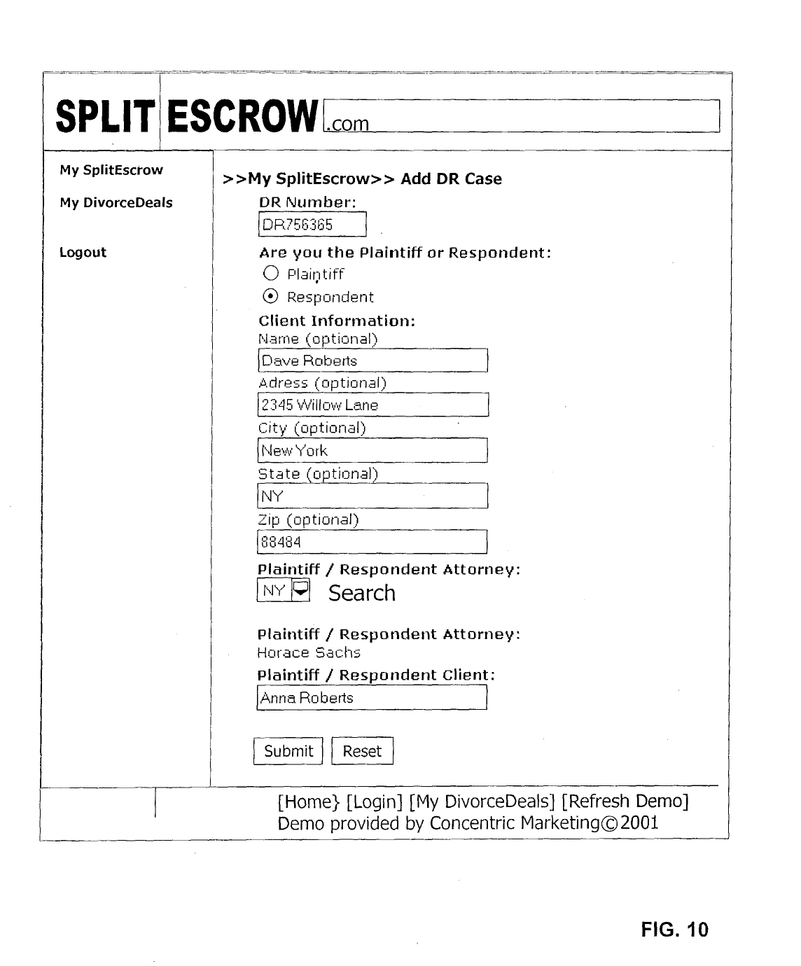

Preferably, the legal representative 102 establishes a case with the escrow service 105 which will be used to identify the entitled parties 101, the legal representatives 102, and each escrow established for the case. FIG. 6 illustrates the preferred escrow service home page from which the legal representative 102 may login. FIG. 7 illustrates the preferred home page for the legal representative 102 that displays all the active cases managed by the legal representative 102. Preferably, as illustrated in FIG. 8, FIG. 9 and FIG. 10, the legal representative 102 completes set-up for a new case, which set-up preferably includes identifying legal representative 102 for other entitled parties.

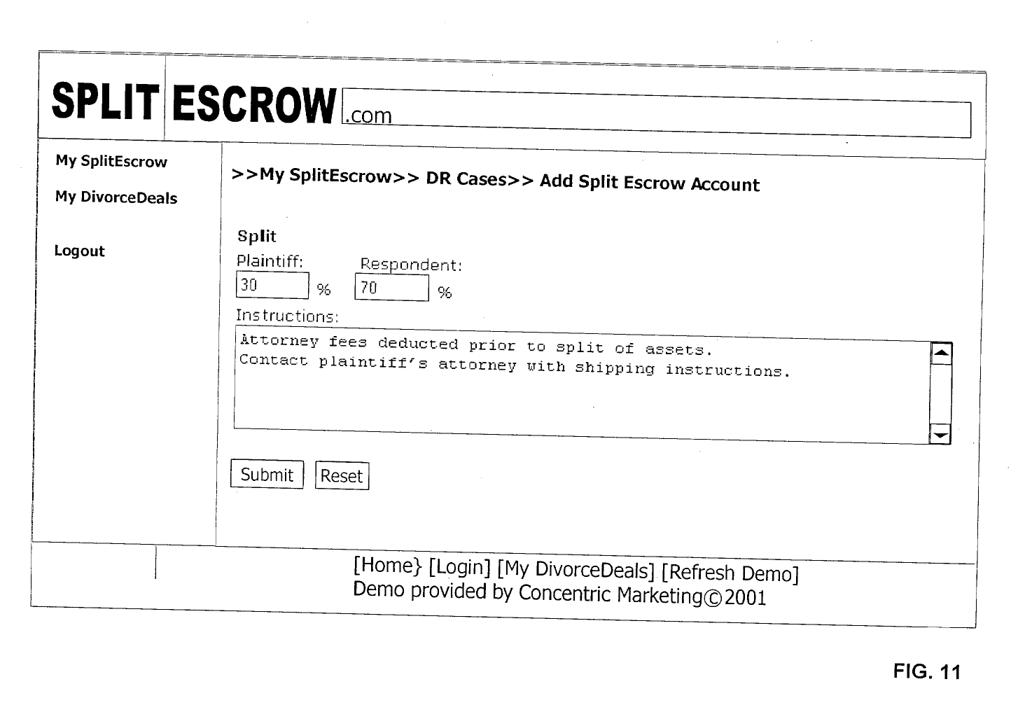

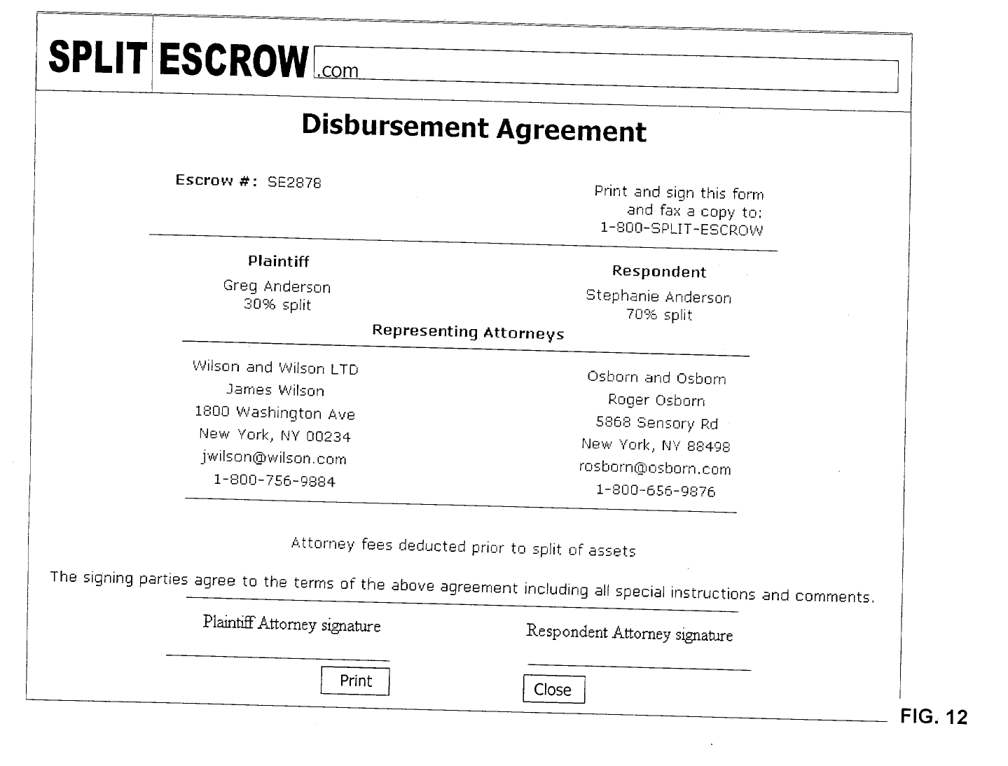

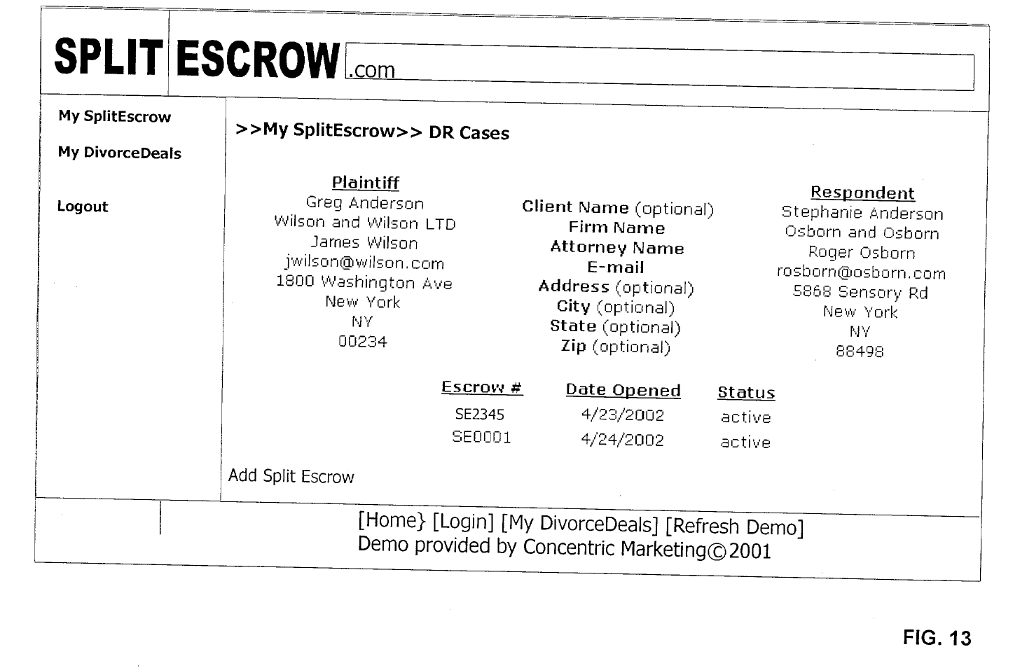

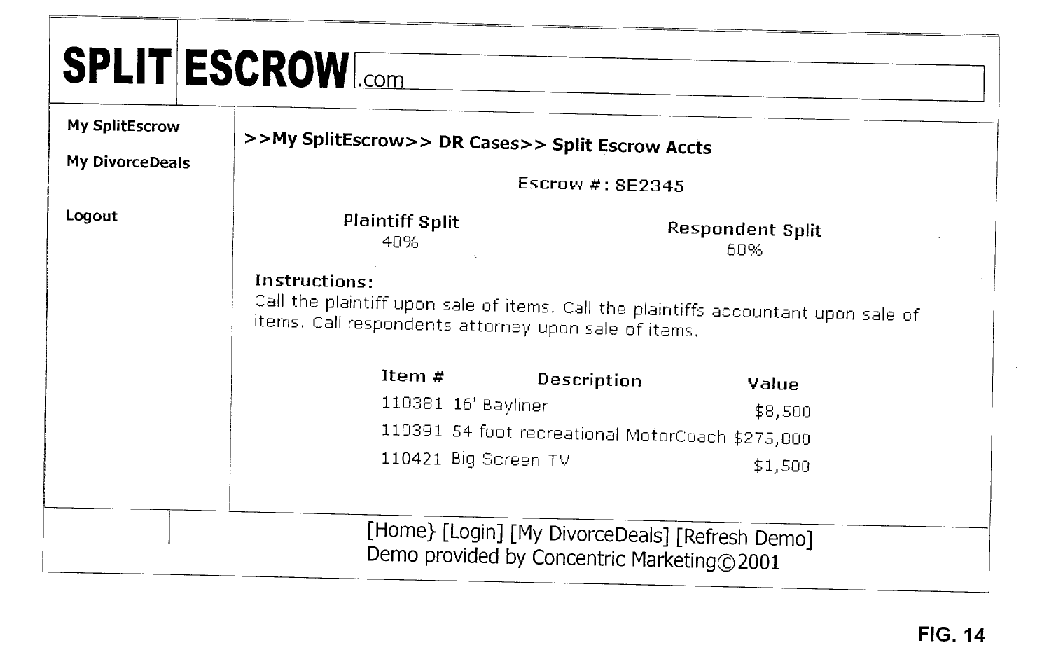

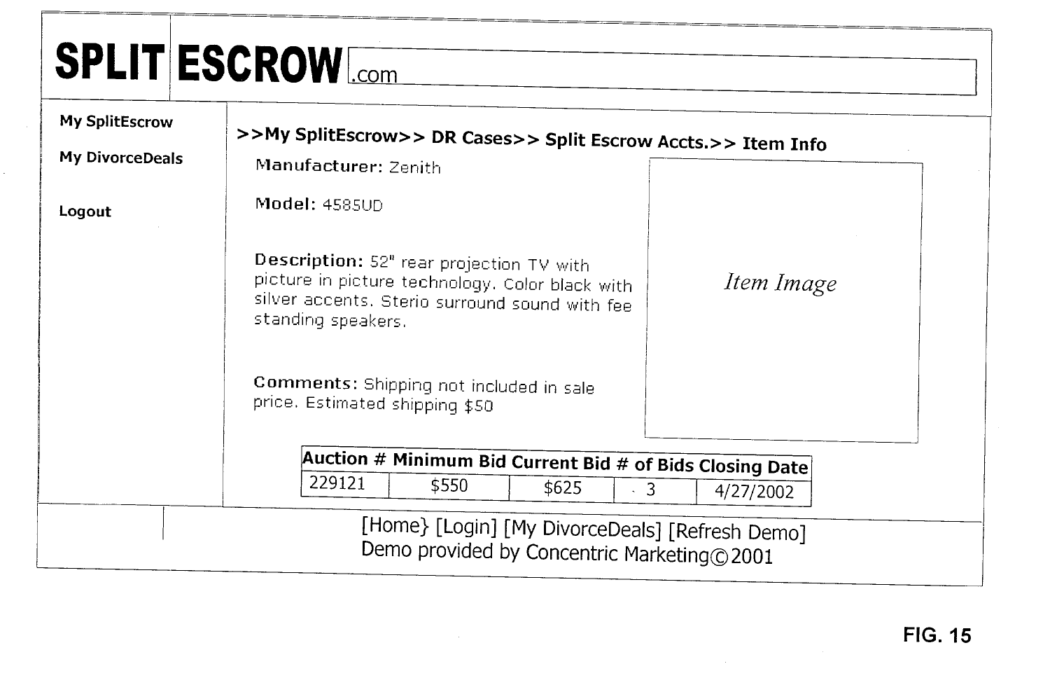

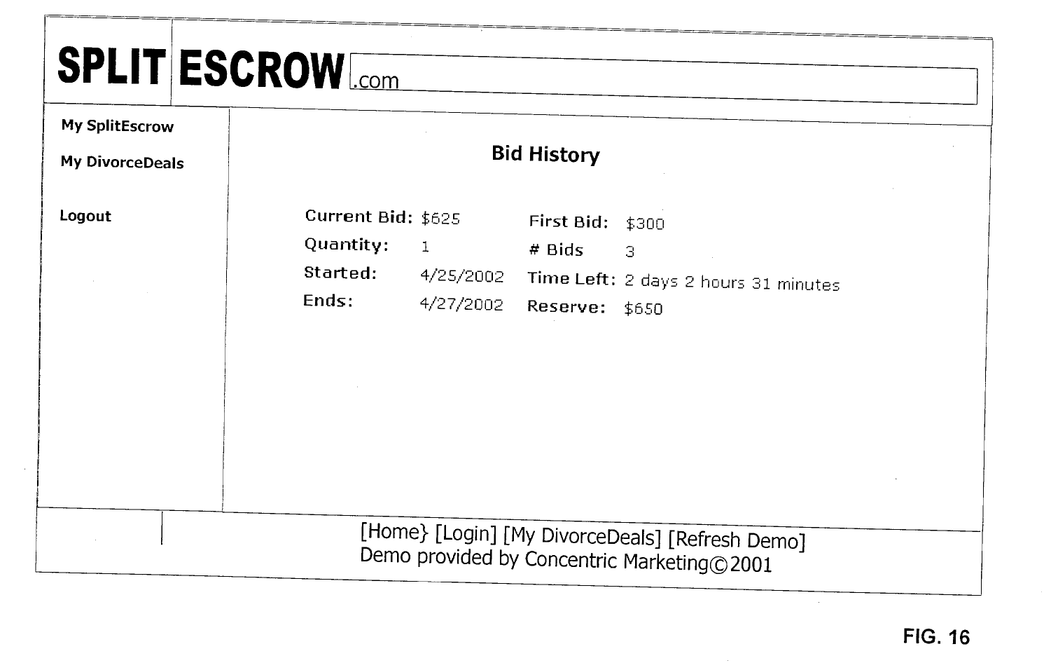

Preferably, as items to be sold and the sharing percentage for the proceeds are identified by the entitled party 101, the legal representative 102 will establish an escrow account and obtain approvals from legal representatives 102 of other entitled parties 101. The set up of an escrow account is illustrated in FIG. 10 and FIG. 11. An example of a preferred disbursement agreement used to obtain approvals of legal representative 102 for each entitled party 101 is shown in FIG. 12. Preferably, after completion of all necessary tasks to establish a case and related escrow account, the legal representative 102 may view a summary of the case as illustrated in FIG. 13. FIG. 14 illustrates a preferred presentation of a detail of assets 108 offered for each escrow account within a case. Preferably, the legal representative 102 may also view the details of each asset 108 offered for sale by the auction service as illustrated in FIG. 15. Preferably, once an asset 108 is offered for sale, the legal representative 102 may review its bid history as shown in FIG. 16.

Step 3

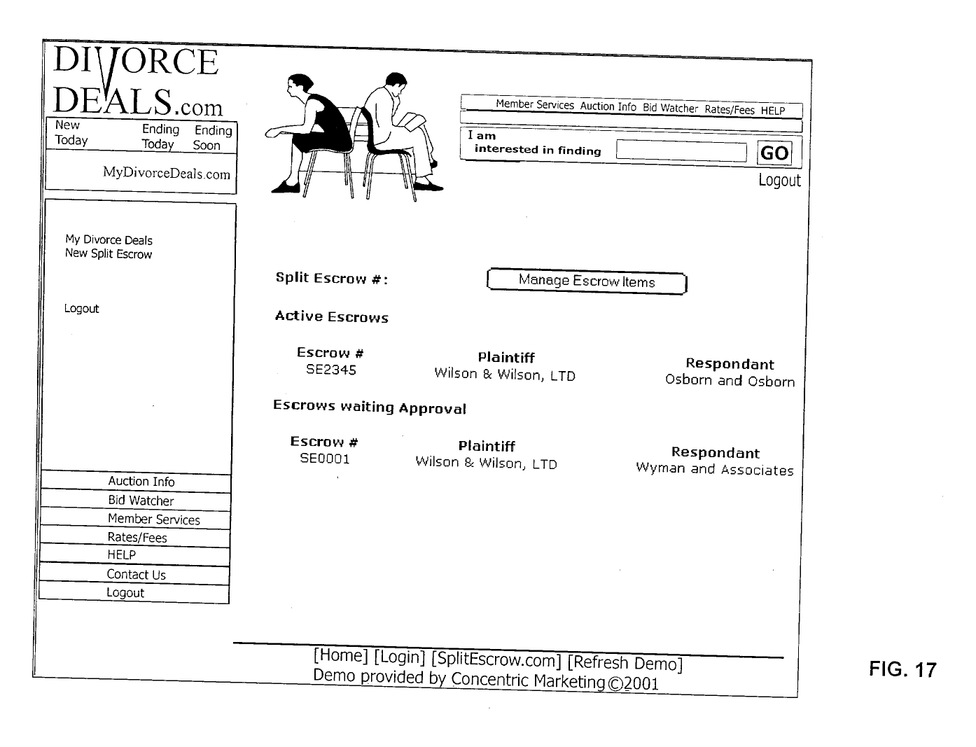

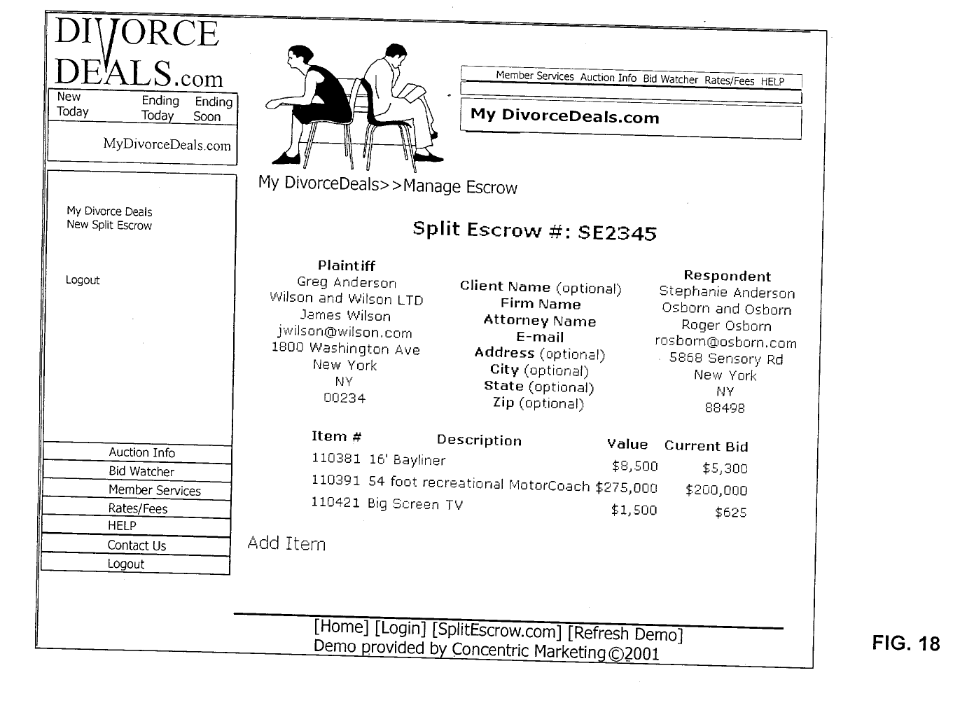

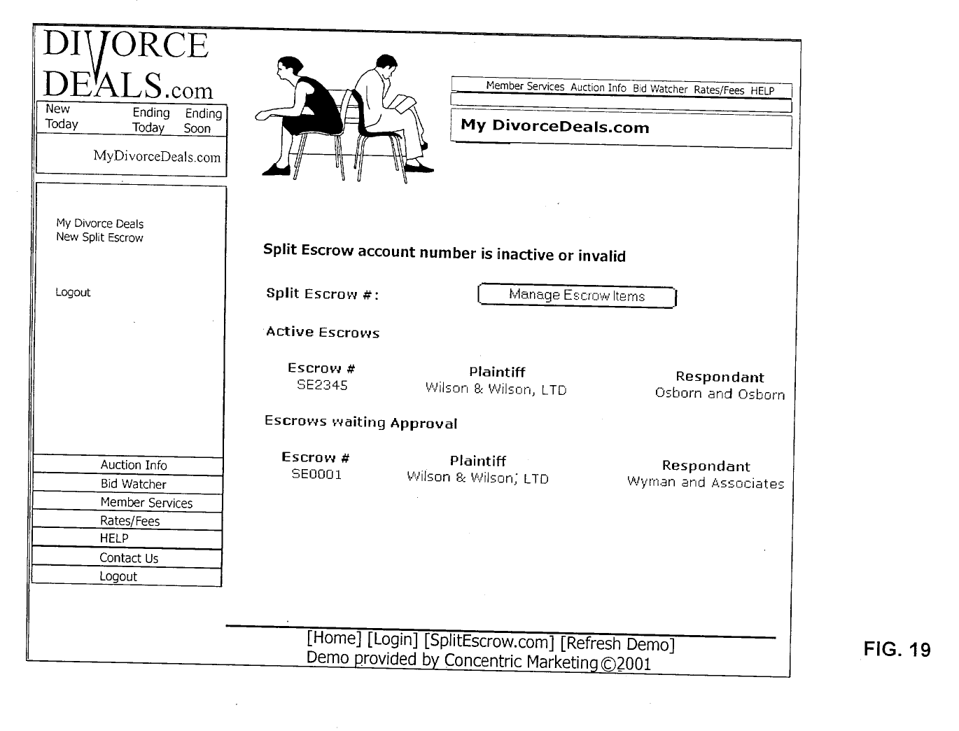

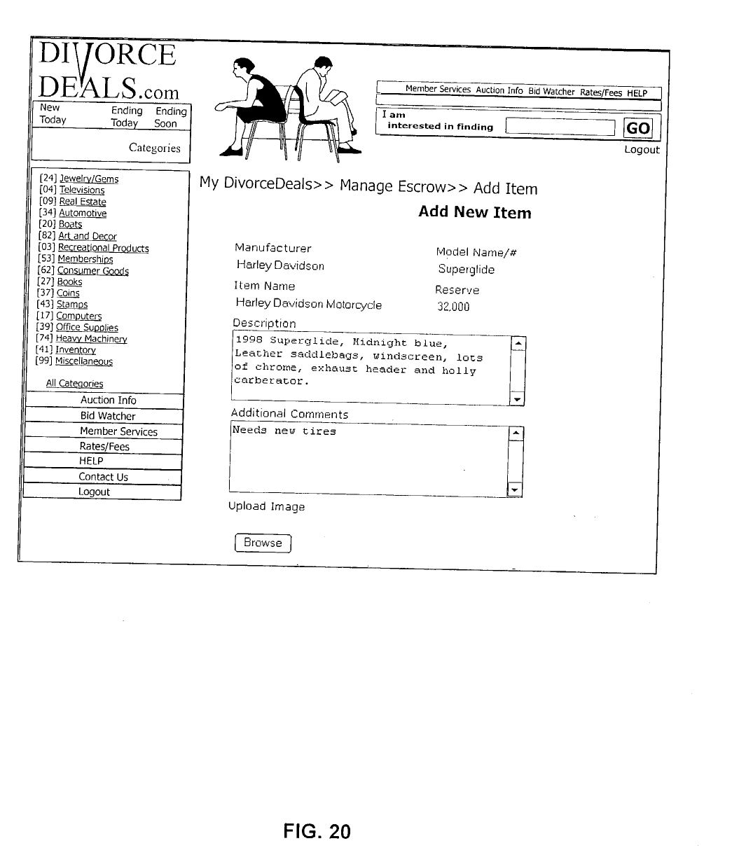

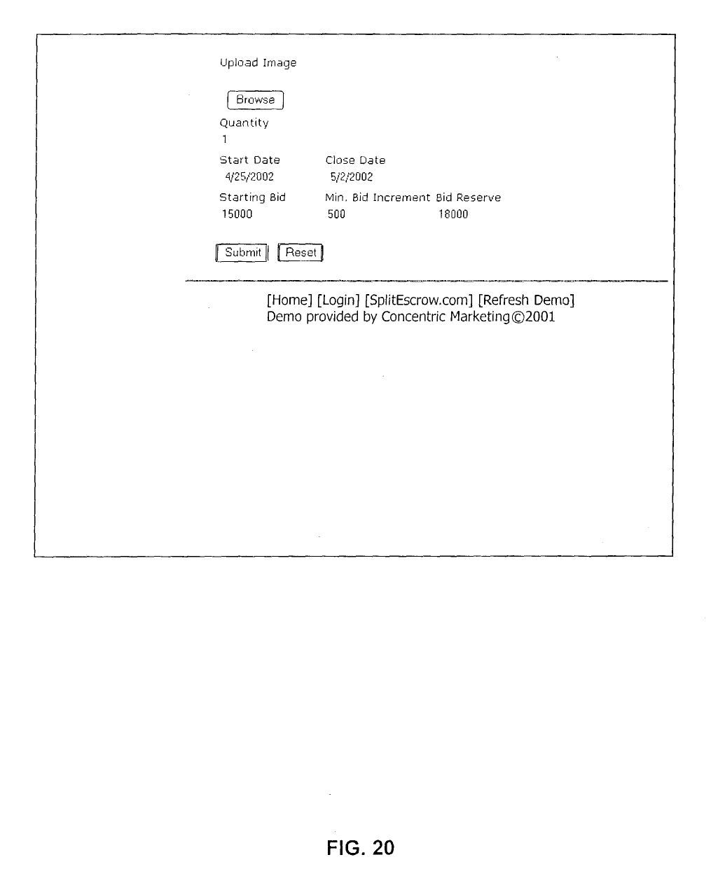

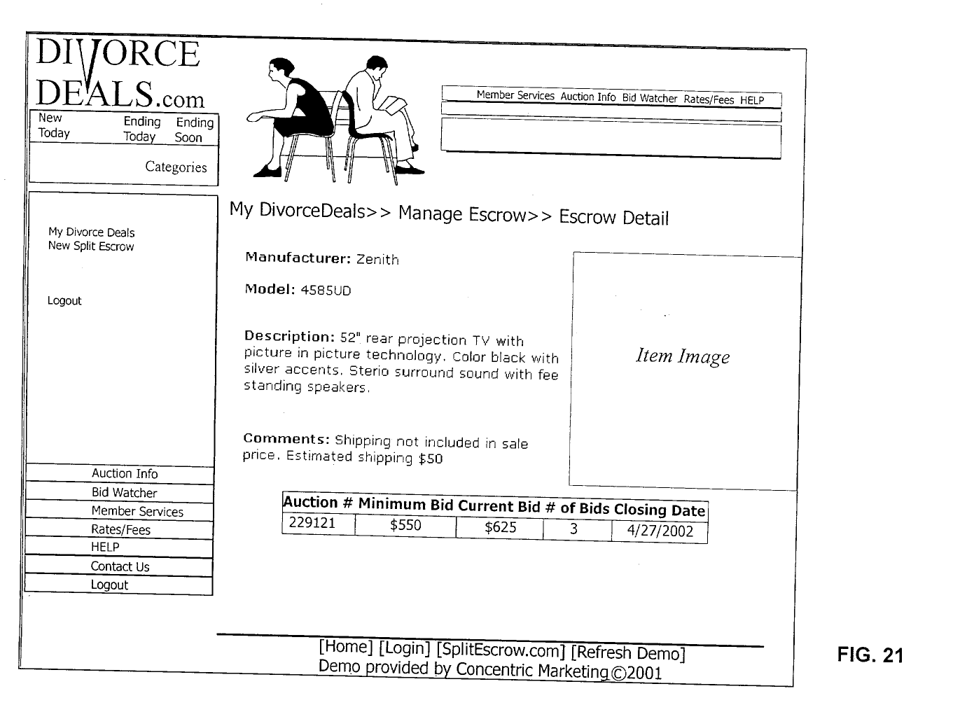

Preferably, the legal representative 102 lists an asset 108 for sale on the auction service 104, providing its description, reserve price, length of time it will be offered and other pertinent information. Preferably, the escrow, established in step 2 for the item, has the legal representative 102 listed as the seller, not the entitled party 101. Preferably, to list an asset 108, the legal representative 102 completes the login to the auction web site and is presented a summary of escrow accounts for which the legal representative 102 has responsibility as shown in FIG. 17. Preferably, as shown in FIG. 18, the legal representative 102 may select a particular escrow account to review the assets 108 offered for sale. If the legal representative 102 enters an invalid escrow number, an error message is presented as shown in FIG. 19. Preferably, a legal representative 102 may add additional assets 108 to an active escrow account in the manner illustrated in FIG. 20. As shown in FIG. 21, after entry of an item, the legal representative 102 may review the information to be presented to potential buyers 103. The auction service 104 is preferably available to the public for access and submission of bids on items listed for sale.

Step 4

Preferably, potential buyers 103 visit the auction service 104 to view listed assets 108 available for bid and may make offers that are stored until the offer period closes. Preferably, at the close of the offer period, the auction service 104 will determine the successful buyer 103 for a listed asset 108. The auction service 104 may, under appropriate circumstances, also accept items from other parties for listing and sale as well as assets 108 from the escrow service 105.

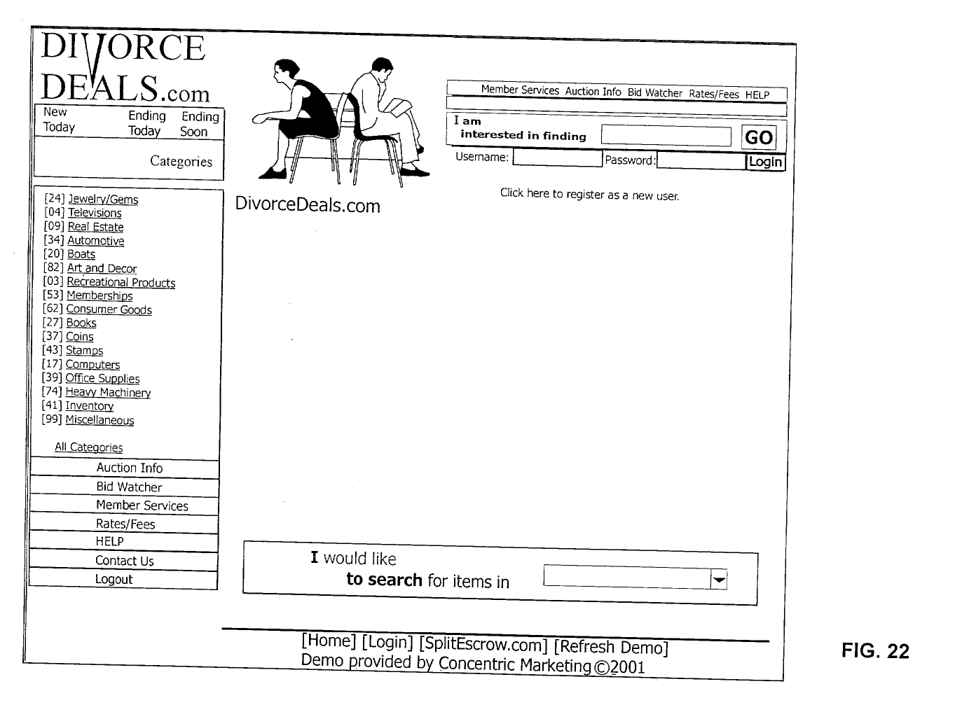

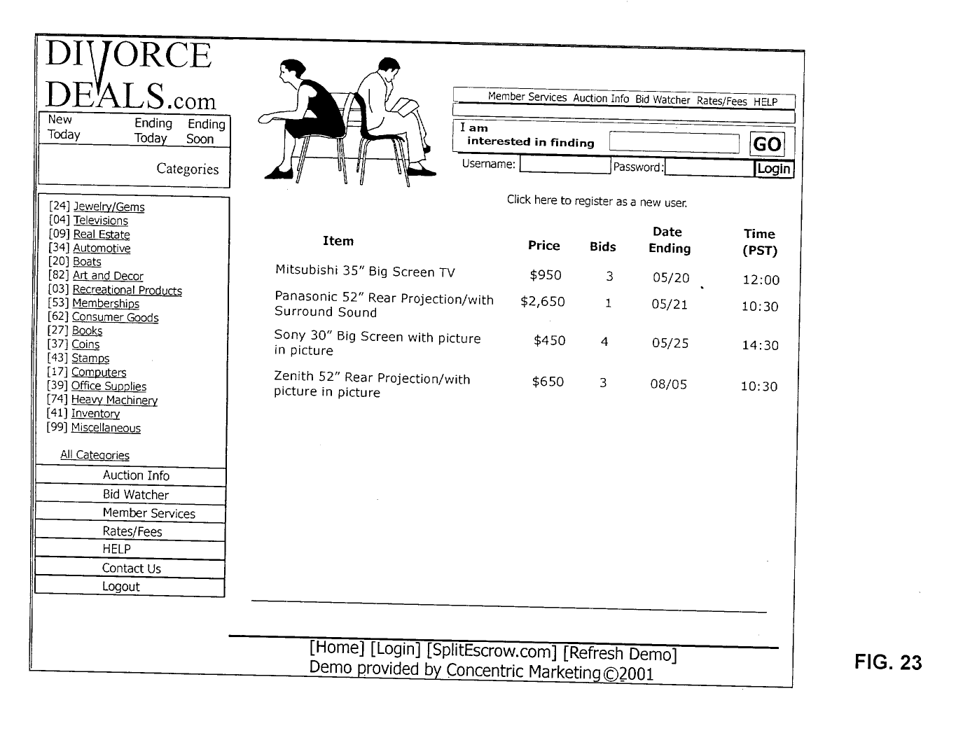

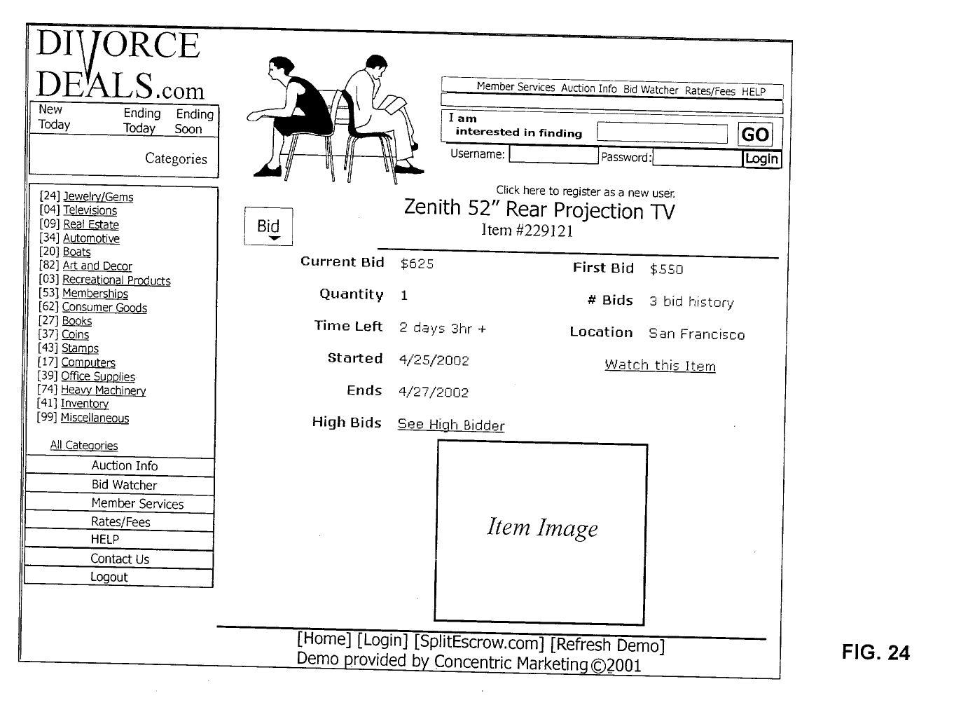

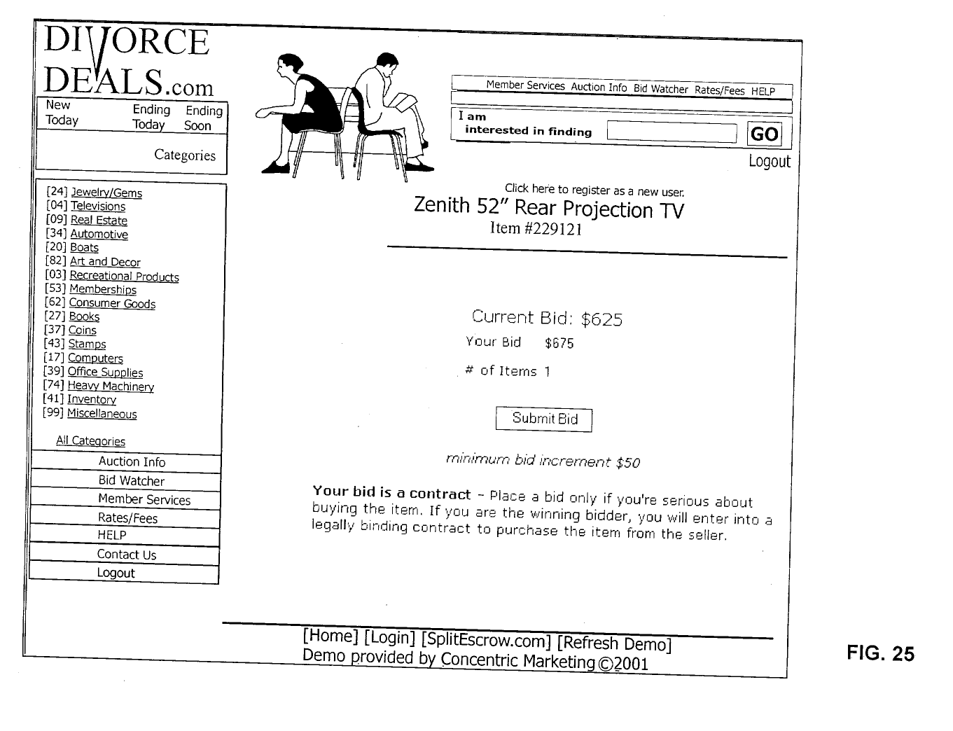

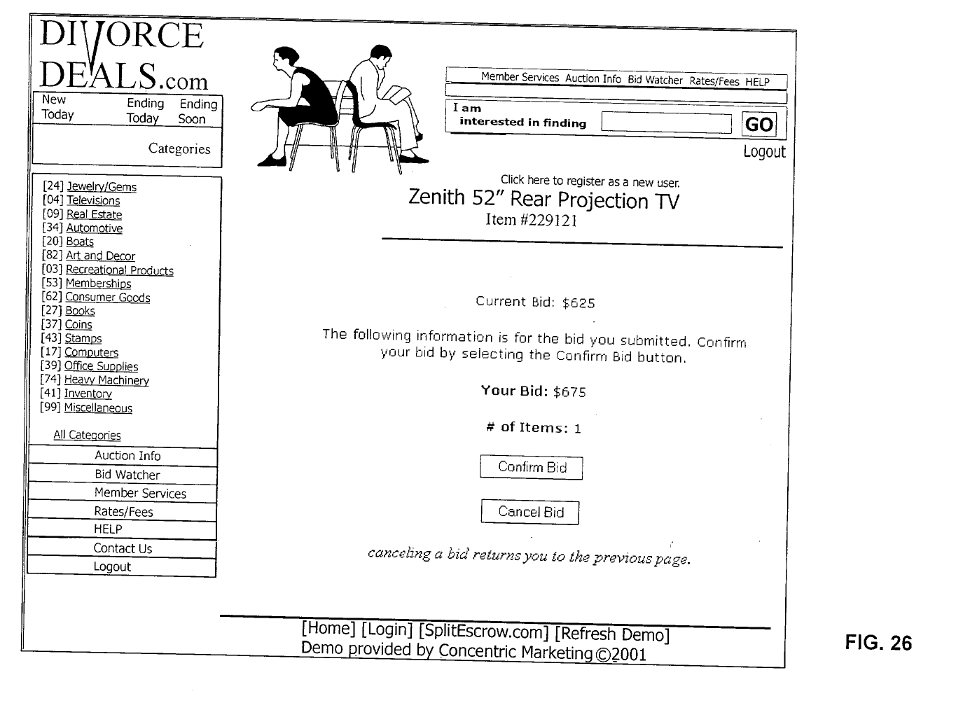

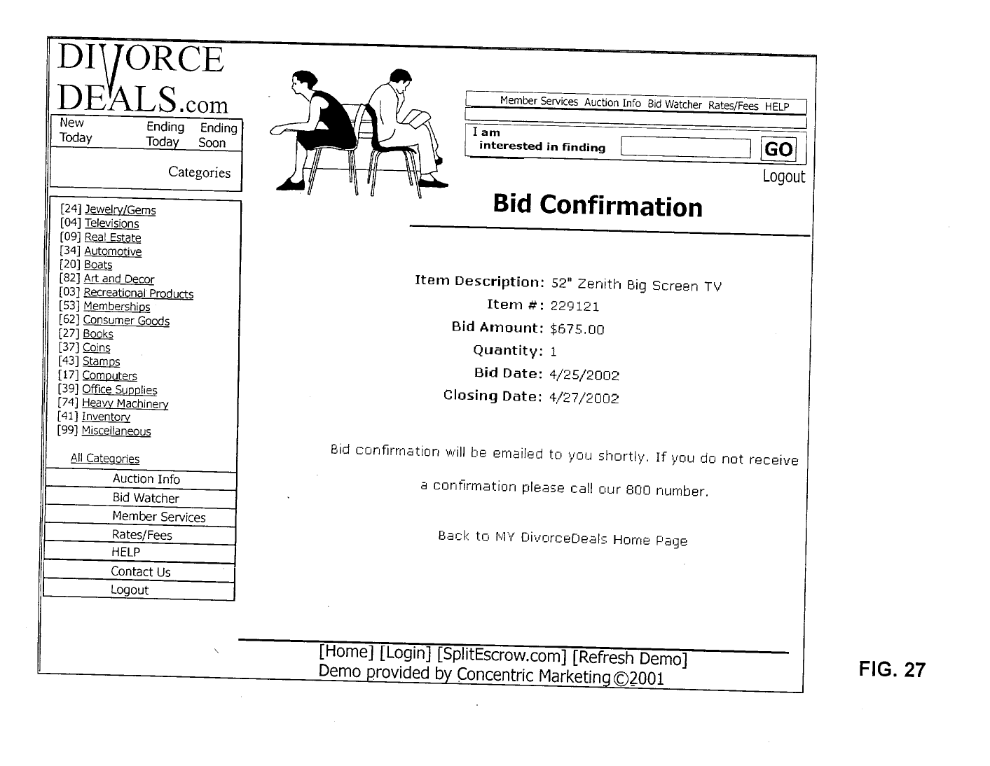

Preferably, buyers 103 accessing the web site of auction service 104 will be presented a home page, as shown in FIG. 22. Preferably, the home page will allow the buyer 103 to complete a variety of actions, including searching for a particular asset 108. The preferred result of a search using a keyword is shown in FIG. 23, which search provides a list of assets 108 and summary information about the auction status of the asset 108. Preferably, the buyer 103 may then display additional auction status information about the asset 108 as shown in FIG. 24. Preferably from the screen illustrated in FIG. 24, the buyer 103 may submit a bid for the asset 108. Preferably, buyer 103 will then complete the submission and acceptance of a bid using the screens illustrated in FIG. 25, FIG. 26 and FIG. 27.

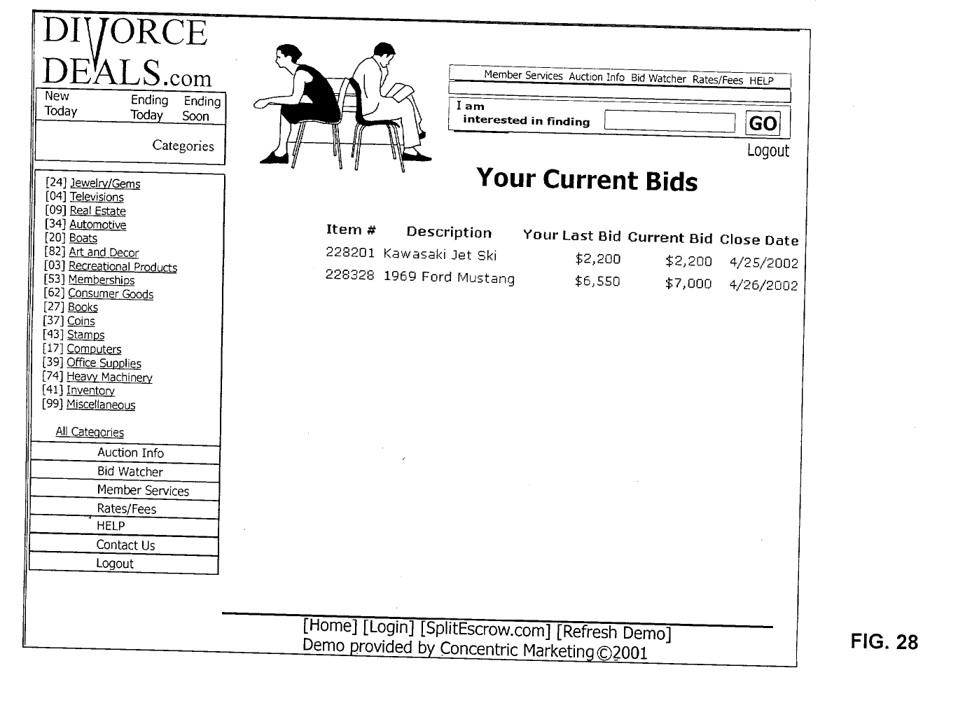

Preferably, buyers 103 must register and login with the auction service 104 to submit bids and review any current bids they may have. FIG. 28 illustrates a preferred summary list of bids submitted by a buyer 103.

Step 5

Preferably, the auction service 104 will notify the escrow service 105 of the name, e-mail address and the winning bid amount of the successful buyer 103.

Step 6

Preferably, the escrow service 105 sends an e-mail to the buyer 103 with instructions regarding how to access the escrow service 105 using the provided unique password for security.

Step 7

Preferably, the escrow service 105 will accept credit card payment by buyer 103 and place the collected amount in the escrow established in step 2.

Step 8

Preferably, after payment is received, a shipping service 109 is notified with instructions for pickup and delivery of the asset 108 by the escrow service 105. Preferably, the entitled party 101 holding the asset 108 will be notified of the sale of the item and when the asset 108 will be picked up by the selected shipping service 109.

Step 9

Preferably, the selected shipping service 109 delivers the asset 108 to the buyer 103 and provides the date of receipt of the asset 108 by the buyer 103 to the escrow service 105.

Step 10

Preferably, the buyer 103 notifies the escrow service 105 that the asset 108 is acceptable.

Step 11

Preferably, once notice of acceptance has been received or the acceptance period has expired without notice of rejection, the escrow service 105 sends the net proceeds to the trust account of (respective) legal representative 102 for each of the entitled parties 101. Preferably, net proceeds are determined by subtracting the auction fees and escrow fees from the amount paid by the buyer. Preferably, the net proceeds amount sent to the trust account for each respective legal representative 102 for each entitled party 101 is determined by the agreed percentage split for the escrow which included the asset.

Step 12

Preferably, the legal representative 102 for each entitled party 101 will periodically send the net proceeds to their respective entitled parties 101.

Step 13

Preferably, the escrow service 105 calculates and sends the total auction fees due to the auction service 104 for the assets successfully sold during the period.

According to a preferred embodiment of the present invention, as shown in FIG. 2, the preferred system and method for completing returns of assets 108 which are rejected by buyers 103 encompasses seven steps which ensure satisfactory return of the asset 108 and the return of the money to buyer 103.

Step 14

Preferably, the rejection notice, that the asset 108 was not acceptable, is received from the buyer 103 within the acceptance period. Preferably, the acceptance period was establish as a specific number of days after receipt of the asset 108 by the buyer 103 as evidenced by the notice of the date of receipt provided by the shipping service 109. Preferably, the notice of rejection is sent to the escrow service 105 by e-mail. An alternate preferred method is receipt of the rejection notice via telephone.

Step 15

Preferably, on receipt of rejection of the asset 108 by the buyer 103, the escrow service 105 will request pickup and shipment by the shipping service 109 to return the asset 108 to the entitled party 101 which previously held the asset 108. The escrow service 105 then provides notice of return shipping instructions to the buyer 103.

Step 16

Preferably, the shipping service 109 delivers the asset 108 to the entitled party 101.

Step 17

Preferably, the shipping service notifies the escrow service 105 of the date of receipt of the asset 108 by the entitled party 101.

Step 18

Preferably, escrow service 105 requests and receives authorization to return the payment of buyer 103.

Step 19

Preferably, the escrow service 105 returns payment to the buyer 103. According to a preferred embodiment of the present invention, as shown in FIG. 3, the preferred system and method for completing the sale and delivery of items that cannot be delivered by traditional means or are of high value, such as jewelry, requires a variation in the delivery and approval method. Preferably, a national chain retail jewelry brokering entity 110 contracts with the escrow service 105 to provide a description, safekeeping and transfer services. Upon reading this specification, those skilled in the art will now understand that, under appropriate circumstances, considering such issues as the type of assets, cost, convenience, etc., other brokering entities 110 such as, for example, a yacht sales company, a storage company, a national chain retail jewelry store, a pawn shop, etc., may suffice.

Preferably, steps one through seven and eleven through thirteen in FIG. 3 are the same as described for FIG. 1.

Step 20

Preferably, after an asset 108 that must be delivered through a brokering entity 110 is to be placed in an escrow account for sale, the escrow service 105 requests the entitled party 101 holding the asset 108 to transfer it to the safekeeping of a brokering entity 110.

Step 21

Preferably, when the asset 108 is received by the brokering service, a description is completed by persons who have particular qualifications for describing the asset 108. For example, diamond jewelry would be described by a certified gemologist. This description of asset 108 is then provided by the escrow service 105 to the auction service 104 for presentation to buyers 103.

Step 22

Preferably, the escrow service 105 will notify the selected brokering entity 110 of the buyer 103, the location of the buyer 103 and the acceptance period the buyer 103 will have to accept or reject the asset 108.

Step 23

Preferably, the escrow service 110 will notify the buyer 103 of the availability of the asset 108 and the location where it can be inspected. Preferably, the buyer 103 will complete inspection of the asset 108 within the acceptance period.

Step 24

Preferably, the buyer 103 inspects the asset 108 at the specified location of the brokering entity 110 and decides to either accept or reject it. Preferably, on acceptance, the asset 108 is delivered to the buyer 103. Preferably, on rejection, the asset 108 continues to be held by brokering entity 110.

Step 25

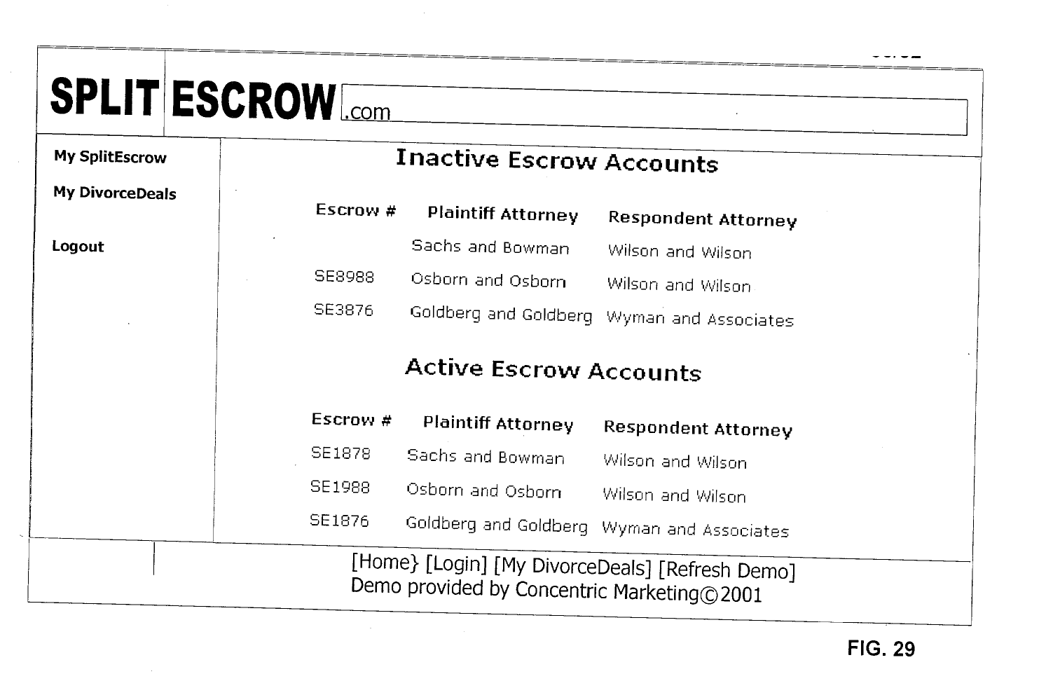

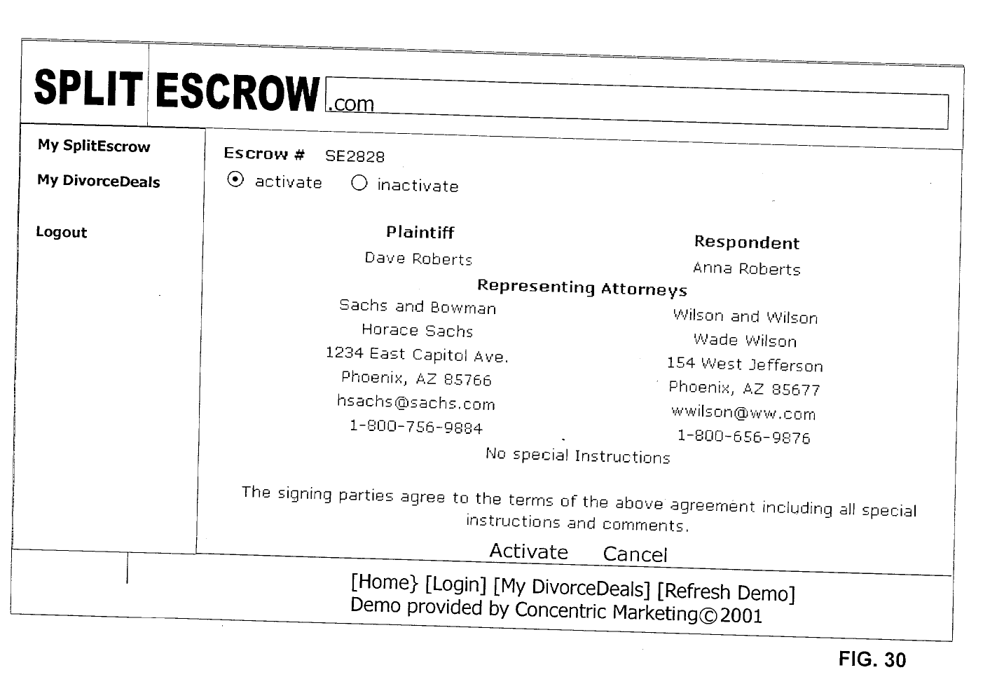

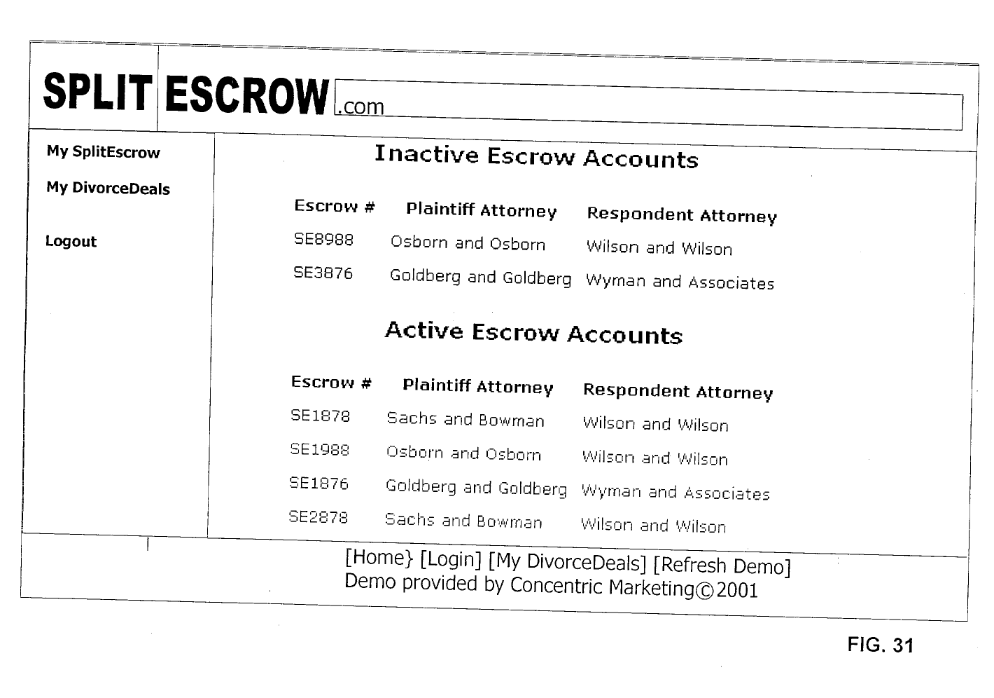

Preferably, the brokering entity 110 is periodically paid the brokering fees earned from assets 108 held and presented. According to a preferred embodiment of the present invention, the escrow service administrator may deactivate escrow accounts after assets 108 are no longer available for sale by the auction service 104. Preferably, such escrow service administrator may access these functions from the escrow service 105 web site home page or otherwise. Preferably, login is accomplished from the home page as illustrated in FIG. 22. Preferably, the escrow service administrator is presented a list of all current escrow accounts as shown in FIG. 29. Preferably from this screen, the escrow service administrator may select an escrow account for deactivation as shown in FIG. 30. Preferably, as illustrated in FIG. 31, the account is no longer shown as an active escrow, which prevents additional assets 108 from being offered for sale.

Although applicant has described applicant's preferred embodiments of this invention, it will be understood that the broadest scope of this invention includes such modifications as diverse shapes and sizes and materials and uses. Such scope is limited only by the below claims as read in connection with the above specification.

Further, many other advantages of applicant's invention will be apparent to those skilled in the art from the above descriptions and the below claims.

What is claimed is:

1) An escrow system for percentage splitting of proceeds by at least one escrow service from at least one sale on behalf of at least one instructing entity among at least one entitled party comprising, in combination:
a) computer interface means for assisting at least one input of escrow information by at least one instructing entity;
b) computer interface means for assisting at least one input of at least one asset information by at least one instructing entity;
c) computer database means for storing such escrow information;
d) computer database means for storing such asset information;
e) computer processor means for sharing at least some such asset information with at least one auction service;
f) computer processor means for assisting receiving information about at least one buyer from such at least one auction service;
g) computer database means for storing information of such at least one buyer;
h) computer interface means for assisting at least one input of at least one payment from such at least one buyer;
i) computer processor means for assisting shipping such at least one asset to such at least one buyer;
j) computer processor means for calculating amounts due to such at least one auction service for at least one asset purchased;
k) computer processor means for calculating amounts due to such at least one escrow service for such at least one asset purchased; and
l) computer processor means for calculating payment due to such at least one entitled party.

2) An escrow system for percentage splitting of proceeds by at least one escrow service from at least one sale on behalf of at least one instructing entity among at least one entitled party comprising, in combination:
a) at least one computer interface system structured and arranged to assist at least one input of escrow information by such at least one instructing entity;
b) at least one computer interface system structured and arranged to assist at least one input of asset information by such at least one instructing entity;
c) at least one database system structured and arranged to store such escrow information;
d) at least one database system structured and arranged to store such asset information;
e) at least one computer processor system structured and arranged to share at least some of such asset information with at least one auction service;
f) at least one computer processor system structured and arranged to receive buyer information about at least one buyer from such at least one auction service;
g) at least one database system structured and arranged to store such buyer information;
h) at least one computer interface system structured and arranged to assist at least one input of payment from such at least one buyer;
i) at least one computer processor system structured and arranged to ship at least one asset to such at least one buyer;
j) at least one computer processor system structured and arranged to calculate amounts due to such at least one auction service for at least one asset purchased;
k) at least one computer processor system structured and arranged to calculate amounts due to such at least one escrow service for such at least one asset purchased; and
l) at least one computer processor system structured and arranged to calculate payment due to such at least one entitled party.

3) The escrow system according to claim 2, wherein such at least one computer interface system structured and arranged to assist at least one input of such payment from such at least one buyer further comprises:
a) at least one computer processor system structured and arranged to create at least one unique password for each such at least one asset purchased;
b) at least one computer processor system structured and arranged to notify such at least one buyer of such at least one unique password for such at least one asset purchased by such at least one buyer;
c) at least one computer interface system structured and arranged to control payment input access utilizing such at least one unique password for such at least one asset purchased;
d) at least one computer interface system structured and arranged to assist at least one input of such payment by such at least one buyer with respect to such at least one asset purchased; and
e) at least one database system structured and arranged to store such payment with respect to such at least one asset purchased from such at least one buyer.

4) The escrow system according to claim 2, wherein such at least one computer processor system structured and arranged to ship such at least one asset to such at least one buyer further comprises:
a) at least one computer processor system structured and arranged to notify at least one shipper of shipping instructions;
b) at least one computer interface system structured and arranged to assist at least one input of at least one date of receipt of such at least one asset by such at least one buyer, provided by such at least one shipper;
c) at least one computer processor system structured and arranged to calculate at least one acceptance period for such at least one buyer based on such at least one date of receipt;
d) at least one computer interface system structured and arranged to assist at least one input of such at least one acceptance notice received during such at least one acceptance period from such at least one buyer of such at least one asset purchased; and
e) at least one computer processor system structured and arranged to complete at least one sale after such at least one acceptance period in the absence of such at least one acceptance notice from such at least one buyer.

5) The escrow system according to claim 4, wherein such at least one computer processor system structured and arranged to notify such at least one shipper of such shipping instructions further comprises:
a) at least one computer interface system structured and arranged to assist at least one input of at least one preferred shipping service;
b) at least one database system structured and arranged for storing such at least one preferred shipping services;
c) at least one computer processor system structured and arranged to select such at least one shipping service with respect to shipping such at least one asset purchased by such at least one buyer;
d) at least one computer interface system structured and arranged to assist at least one input of shipping instructions for such at least one asset purchased by such at least one buyer;
e) at least one computer processor system structured and arranged to notify selected such at least one shipping service of such shipping instructions; and
f) at least one computer processor system structured and arranged to notify such at least one entitled party of such shipping instructions.

6) The escrow system according to claim 2, wherein such at least one computer processor system structured and arranged to calculate such payment amount due to such at least one entitled party further comprises:
a) at least one computer processor system structured and arranged to calculate such payment using at least one asset purchase price, subtracting amount due to such at least one auction service and subtracting amount due to such at least one escrow service.

7) The escrow system according to claim 2, wherein such at least one computer processor system structured and arranged to calculate such payment due to such at least one entitled party further comprises:
a) at least one computer processor system structured and arranged to send such payment to such at least one instructing entity.

8) The escrow system according to claim 2, further comprising:
a) at least one computer interface system structured and arranged to assist at least one input of identification of such at least one asset to be described and held for presentation and safekeeping by at least one brokering entity having at least one public location;
b) at least one computer interface system structured and arranged to assist at least one input of description of such at least one asset by such brokering entity by at least one instructing entity;
c) at least one computer processor system structured and arranged to notify at least one brokering entity of such at least one asset;
d) at least one computer processor system structured and arranged to notify such at least one brokering entity of at least one location of at least one buyer;
e) at least one computer interface system structured and arranged to assist at least one input of at least one acceptance notice from such at least one brokering entity on behalf of such at least one buyer of such at least one asset purchased received during at least one acceptance period; and
f) at least one computer processor system structured and arranged to calculate payment due to such at least one brokering entity.

9) The escrow system according to claim 2, further comprising:
a) at least one computer interface system structured and arranged to assist at least one input of such at least one rejection notice from such at least one buyer of such at least one asset purchased, received during at least one acceptance period;
b) at least one computer processor system structured and arranged to notify at least one shipper of shipping instructions with respect to rejection of such at least one asset purchased;
c) at least one computer interface system structured and arranged to assist at least one input of at least one date of receipt of such at least one rejected asset purchased, provided by such at least one shipper; and
d) at least one computer processor system structured and arranged to return payment from such at least one buyer.

10) The escrow system according to claim 9, wherein such at least one computer interface system structured and arranged to assist at least one input of such at least one rejection notice from such at least one buyer of such at least one asset purchased, received during such acceptance period further comprises:
a) at least one computer interface system structured and arranged to assist at least one input of such at least one rejection notice received during such at least one acceptance period from such at least one brokering entity on behalf of such at least one buyer of such at least one asset purchased.

11) The escrow system according to claim 2, wherein:
a) the escrow system is substantially an Internet website client-server computer system;
b) the auction service is substantially an Internet website client-server computer system;
c) the escrow system and auction service system share asset information; and
d) the escrow system and auction service system share buyer information.

12) The escrow system according to claim 2, wherein:
a) multiple independent escrows are permitted for each such at least one entitled party;
b) each such independent escrow may have a different such percentage split of the proceeds;
c) attorneys are such instructing entities; and
d) such at least one attorney for each such entitled party may receive such proceeds on behalf of such at least one entitle party.

13) The escrow system according to claim 2, wherein:
a) such at least one asset comprises at least one asset derived from a divorce.

14) The escrow system according to claim 2, wherein:
a) such at least one asset comprises at least one asset derived from a bankruptcy.

15) The escrow system according to claim 2, wherein:
a) such at least one asset comprises at least one asset derived from a decedent's estate.

16) A computer software system for an escrow system for percentage splitting of proceeds by at least one escrow service from at least one sale on behalf of at least one instructing entity among at least one entitled party comprising, in combination, the steps of:
a) assisting at least one input of escrow information by at least one instructing entity;
b) assisting at least one input of at least one asset information by at least one instructing entity;
c) storing such escrow information;
d) storing such asset information;
e) sharing at least some such asset information with at least one auction service;
f) receiving information about at least one buyer from such at least one auction service;
g) storing information of such at least one buyer;
h) assisting at least one input of at least one payment from such at least one buyer;
i) shipping such at least one asset to such at least one buyer;
j) calculating amounts due to such at least one auction service for at least one asset purchased;
k) calculating amounts due to such at least one escrow service for such at least one asset purchased; and
l) calculating payment due to such at least one entitled party.

17) The computer software system for an escrow system according to claim 16, wherein such assisting at least one input of such at least one payment from such at least one buyer further comprises the steps of:
a) creating at least one unique password for each such at least one asset purchased;
b) notifying such at least one buyer of such at least one unique password with respect to such at least one asset purchased by such at least one buyer;
c) controlling payment input access using such at least one unique password for such at least one asset purchased;
d) assisting at least one input of such at least one payment by such at least one buyer with respect to such at least one asset purchased; and
e) storing such at least one payment with respect to such at least one asset purchased from such at least one buyer.

18) The computer software system for an escrow system according to claim 16, wherein such shipping such at least one asset to such at least one buyer further comprises the steps of:
a) notifying at least one shipper of shipping instructions;
b) assisting at least one input of date of receipt of such at least one asset by such at least one buyer, provided by such at least one shipper;
c) calculating at least one acceptance period applicable to such at least one buyer based on such at least one date of receipt;
d) assisting at least one input of at least one acceptance notice received during such at least one acceptance period from such at least one buyer of such at least one asset purchased; and
e) completing at least one sale after such at least one acceptance period in the absence of receiving such at least one acceptance notice from such at least one buyer.

19) The computer software system for an escrow system according to claim 18, wherein such notifying such at least one shipper of such shipping instructions further comprises the steps of:
a) assisting input of at least one preferred shipping service;
b) storing such at least one preferred shipping service;
c) selecting such at least one shipping service with respect to shipping such at least one asset purchased by such at least one buyer;
d) assisting at least one input of such shipping instructions with respect to such at least one asset purchased by such at least one buyer;
e) notifying selected such at least one shipping service of such shipping instructions; and
f) notifying such at least one entitled party of such shipping instructions.

20) The computer software system for an escrow system according to claim 16, wherein such calculating such payment due to such at least one entitled party further comprises the steps of:
a) calculating such payment using at least one asset purchase price, subtracting amount due to such at least one auction service and subtracting amount due to such at least one escrow service.

21) The computer software system for an escrow system according to claim 16, wherein such calculating such payment due to such at least one entitled party further comprises the steps of:
a) sending such payment to such at least one instructing entity.

22) The computer software system for an escrow system according to claim 16, further comprising the steps of:
a) assisting at least one input of identification of such at least one asset to be described and held for presentation and safekeeping by at least one brokering entity having at least one public location;
b) assisting at least one input of description of such at least one asset by such at least one brokering entity by at least one instructing entity;
c) notifying such at least one brokering entity of such at least one buyer for such at least one asset;
d) notifying such at least one brokering entity of at least one location of such at least one buyer;
e) assisting at least one input of at least one acceptance notice from such at least one brokering entity on behalf of such at least one buyer of such at least one asset purchased received during at least one acceptance period; and
f) calculating payment due to such at least one brokering entity.

23) The computer software system for an escrow system according to claim 16, further comprising the steps of:
a) assisting at least one input of at least one rejection notice from such at least one buyer of such at least one asset purchased, received during at least one acceptance period;
b) notifying at least one shipper of shipping instructions with respect to a rejection of such at least one asset purchased;
c) assisting at least one input of at least one date of receipt of such at least one rejected asset purchased, provided by such at least one shipper; and
d) returning payment from such at least one buyer.

24) The computer software system for an escrow system according to claim 23, wherein such assisting at least one input of such at least one rejection notice from such at least one buyer of such at least one asset purchased, received during such at least one acceptance period further comprises the step of:
a) assisting at least one input of such at least one rejection notice received during such at least one acceptance period from such at least one brokering entity on behalf of such at least one buyer of such at least one asset purchased.

25) An escrow system for percentage splitting of proceeds by at least one escrow service from at least one sale on behalf of at least one instructing entity among at least two entitled parties comprising, in combination, the steps of:
a) soliciting instructing entities to be authorized users of such escrow system;
b) inputting such at least one instructing entity authorized by at least one system administrator to use such escrow system;
c) inputting escrow information by such at least one instructing entity;
d) inputting information about at least one asset to be sold by such at least one instructing entity;
e) sending such asset information to at least one auction service;
f) receiving buyer information from such at least one auction service;
g) receiving at least one payment from such at least one buyer of such at least one asset;
h) shipping such at least one asset to such at least one buyer by such at least one shipping service;
i) paying at least one auction service fee from such at least one payment from such at least one buyer to such at least one auction service;
j) paying at least one escrow service fee from such at least one payment from such at least one buyer to such at least one escrow service; and
k) paying at least one remainder of such at least one payment from such at least one buyer to such at least one instructing entity.

26) The escrow system according to claim 25 wherein shipping such at least one asset to such at least one buyer by such at least one shipping service further comprising the steps of;
a) notifying at least one shipping service of shipping instructions;
b) notifying such at least one entitled entity of such shipping instructions;
c) receiving at least one date of receipt by such at least one buyer from such at least one shipping service;
d) calculating at least one acceptance period for such at least one buyer based on such at least one date of receipt; and
e) receiving at least one notice of acceptance of such at least one asset from such at least one buyer within such at least one acceptance period.

27) The escrow system according to claim 26 further comprising the step of:
a) completing at least one sale after such at least one acceptance period when no such at least one notice is received from such at least one buyer.

28) The escrow system according to claim 27 further comprising the steps of:
a) inputting at least one rejection notice from such at least one buyer of such at least one asset purchased, received during such at least one acceptance period;
b) notifying at least one shipper of shipping instructions for rejected such at least one purchased asset;
c) inputting of at least one date of return of at such least one rejected purchased asset, provided by such at least one shipper; and
d) returning such at least one payment from such at least one buyer to such at least one buyer.

29) The escrow system according to claim 28, further comprising the steps of:
a) inputting of identification of such at least one asset to be described and held for presentation and safekeeping by at least one brokering entity having at least one public location;
b) notifying such at least one brokering entity of such at least one asset to be sold;
c) inputting of at least one description of such at least one asset by such at least one brokering entity by at least one instructing entity;
d) notifying such at least one brokering entity of at least one buyer location;
e) receiving, during such at least one acceptance period, such at least one acceptance notice from such at least one brokering entity on behalf of such at least one buyer of such at least one asset; and
f) inputting at least one brokering entity's fee.

30) The escrow system according to claim 28, wherein the step of inputting such at least one rejection notice from such at least one buyer of such at least one asset purchased, received during such at least one acceptance period further comprises:
a) inputting such at least one rejection notice from such at least one brokering entity on behalf of such at least one buyer of such at least one asset, received during such at least one acceptance period.
